(19) United States
(12) Patent Application Publication
(10) Pub. No.: US 2026/0154293 A1
(43) Pub. Date: Jun. 4, 2026

(54) APPROXIMATE NEAREST NEIGHBOR SEARCH METHOD AND APPROXIMATE NEAREST NEIGHBOR SEARCH SYSTEM

(71) Applicant: Kioxia Corporation, Tokyo (JP)

(72) Inventors: Shinichi KANNO, Ota Tokyo (JP); Toru WATABE, Yokohama Kanagawa (JP); Takahiro KURITA, Sagamihara Kanagawa (JP)

(73) Assignee: Kioxia Corporation, Tokyo (JP)

(21) Appl. No.: 19/324,876

(22) Filed: Sep. 10, 2025

(30) Foreign Application Priority Data
Dec. 4, 2024 (JP) 2024-211586

(51) Int. Cl. G06F 16/28; G06F 16/22; G06F 16/2453

(52) U.S. Cl. CPC G06F 16/285; G06F 16/2237; G06F 16/2453

(57) ABSTRACT

According to one embodiment, an approximate nearest neighbor search method manages graph-based index information for defining an inter-cluster graph. The approximate nearest neighbor search method searches for a vector closest to a query vector from vectors belonging to a search start cluster that is closest to the query vector among a plurality of clusters. The approximate nearest neighbor search method selects one or more search target clusters close to the search start cluster while traversing the inter-cluster graph, and searches for a vector closest to the query vector from vectors belonging to each of the one or more search target clusters.

### CROSS-REFERENCE TO RELATED APPLICATIONS

This application is based upon and claims the benefit of priority from Japanese Patent Application No. 2024-211586, filed Dec. 4, 2024, the entire contents of which are incorporated herein by reference.

### FIELD

Embodiments described herein relate generally to approximate nearest neighbor search (ANNS).

### BACKGROUND

Vector databases are used in various fields such as machine learning and data mining. In vector databases, each individual piece of data is stored as a high-dimensional vector including a large number of feature values respectively corresponding to a large number of attributes. In a search stage, a nearest neighbor search is performed to obtain a vector (nearest neighbor vector) closest to a query (query vector) having the same number of dimensions as the number of dimensions of each vector in the vector database by full search.

Recently, an approximate nearest neighbor search has been used instead of the nearest neighbor search. The approximate nearest neighbor search is a method of searching for a vector (approximate nearest neighbor vector) sufficiently close to a query at a high speed, unlike the nearest neighbor search of strictly searching for the nearest neighbor vector by full search. An algorithm using a graph-based index is known as an algorithm capable of searching for an approximate nearest neighbor vector at a relatively high speed with relatively high search accuracy even for a high-dimensional vector set.

When an attempt is made to construct a large-scale vector database allowing searching for a large number of vectors exceeding the billion scale, the data amount of a vector set and the data amount of a graph-based index significantly increases, and it is not possible to dispose the vector set and the graph-based index on a main storage of a computer. Therefore, an approximate nearest neighbor search algorithm in which a graph-based index is disposed on a secondary storage device such as a solid state drive (SSD) has also recently been developed.

In many graph-based indexes, an inter-vector graph having a graph structure in which vectors close to each other are connected by an edge is used. Each edge is represented by edge information in the graph-based index.

In constructing an inter-vector graph for a large-scale vector database of a billion scale or more, the data amount of the entire graph-based index greatly increases due to an increase in the number of pieces of edge information required. As a result, a large storage area is required for storing the graph-based index.

In the inter-vector graph, every time one vector is added to the vector database, it is necessary to register the added vector as a new neighbor vector for each of a large number of other vectors close to the added vector. Therefore, every time a vector is added, it is also necessary to rewrite a large number of pieces of edge information respectively corresponding to a large number of other vectors.

A secondary storage device such as an SSD or a hard disk drive (HDD) has longer latency for access than a DRAM or an SRAM used for main storage. The SSD also has a restriction such as an upper limit of the number of times of rewriting. Therefore, in an algorithm using the inter-vector graph, there is a case where time required to register one vector becomes long, or a case where the secondary storage device reaches the lifetime early due to an increase in the number of times of rewriting by rewriting the edge information.

On the other hand, in an algorithm using a cluster-based index, it is not necessary to rewrite a large number of pieces of edge information. However, in the algorithm using the cluster-based index, it is difficult to search for each vector at a position close to a boundary between clusters, and thus, it is not possible to obtain sufficient search accuracy in many cases.

### BRIEF DESCRIPTION OF THE DRAWINGS

FIG. 1 is a block diagram illustrating a configuration example of an approximate nearest neighbor search system according to an embodiment.

FIG. 2 is a diagram illustrating an example of a hybrid index structure of the approximate nearest neighbor search system according to the embodiment.

FIG. 3 is a diagram illustrating an example of a search process executed in the approximate nearest neighbor search system according to the embodiment by using the hybrid index structure.

FIG. 4 is a diagram illustrating a configuration example of an inter-cluster graph used in the approximate nearest neighbor search system according to the embodiment.

FIG. 5 is a diagram for describing cluster search using a hierarchical cluster and approximate nearest neighbor vector search using the inter-cluster graph.

FIG. 6A is a diagram illustrating a search process for a search start cluster.

FIG. 6B is a diagram illustrating a search process for a first search target cluster closest to the search start cluster.

FIG. 6C is a diagram illustrating a search process for a second search target cluster.

FIG. 6D is a diagram illustrating a search process for one or more neighbor clusters obtained by excluding an already searched cluster from neighbor clusters of the second search target cluster.

FIG. 7A is a diagram illustrating a search process for a search start cluster.

FIG. 7B is a diagram illustrating a search process for a search target cluster having a direction closest to a direction from a reference position of the search start cluster to a query.

FIG. 7C is a diagram illustrating a search process for one or more neighbor clusters obtained by excluding an already searched cluster from neighbor clusters of a search target cluster having a direction closest to the direction from the reference position of the search start cluster to the query.

FIG. 8 is a diagram illustrating an index update process for adding a new cluster.

FIG. 9 is a diagram illustrating an index update process for deleting a cluster whose number of belonging vectors is zero.

FIG. 10 is a diagram illustrating an example of higher layer cluster index information corresponding to each higher layer cluster.

FIG. 11 is a diagram illustrating an example of lowest layer cluster index information corresponding to each lowest layer cluster.

FIG. 12A is a diagram for describing a part of a principle of approximate nearest neighbor vector search using a distance between vectors.

FIG. 12B is a diagram for describing another part of the principle of the approximate nearest neighbor vector search using the distance between vectors.

FIG. 12C is a diagram for describing still another part of the principle of the approximate nearest neighbor vector search using the distance between vectors.

FIG. 13A is a diagram for describing a part of a principle of approximate nearest neighbor vector search using a distance between vectors and a direction between the vectors.

FIG. 13B is a diagram for describing another part of the principle of the approximate nearest neighbor vector search using the distance between vectors and the direction between the vectors.

FIG. 13C is a diagram for describing still another part of the principle of the approximate nearest neighbor vector search using the distance between vectors and the direction between the vectors.

FIG. 13D is a diagram for describing still yet another part of the principle of the approximate nearest neighbor vector search using the distance between vectors and the direction between the vectors.

FIG. 14 is a flowchart illustrating an example of a procedure of a process of constructing the hybrid index structure including the hierarchical cluster and the inter-cluster graph.

FIG. 15 is a flowchart illustrating an example of a procedure of an approximate nearest neighbor cluster (search start cluster) search process.

FIG. 16 is a flowchart illustrating an example of another procedure of the approximate nearest neighbor cluster (search start cluster) search process.

FIG. 17 is a flowchart illustrating an example of a procedure of an approximate nearest neighbor vector search process.

FIG. 18 is a flowchart illustrating an example of a procedure of a first index update process executed based on a vector added to a data set of a vector database.

FIG. 19 is a flowchart illustrating an example of a procedure of an in-cluster nearest neighbor vector search process executed in a case where a cluster on which an addition process is being executed is determined as the search start cluster.

FIG. 20 is a flowchart illustrating an example of a procedure of a second index update process executed when a vector is deleted from the data set of the vector database.

FIG. 21 is a diagram illustrating a first modification example for the approximate nearest neighbor cluster (search start cluster) search process.

FIG. 22 is a diagram illustrating a second modification example for the approximate nearest neighbor cluster (search start cluster) search process.

FIG. 23 is a diagram illustrating a third modification example for the approximate nearest neighbor cluster (search start cluster) search process.

### DETAILED DESCRIPTION

Various embodiments will be described hereinafter with reference to the accompanying drawings.

One embodiment provides an approximate nearest neighbor search method and an approximate nearest neighbor search system capable of reducing an amount of data that needs to be rewritten along with update of a graph-based index and capable of performing approximate nearest neighbor search with sufficient search accuracy.

In general, according to one embodiment, an approximate nearest neighbor search method for a vector database configured to store a plurality of vectors each including a plurality of feature values respectively corresponding to a plurality of dimensions is provided. The approximate nearest neighbor search method manages cluster-based index information for defining a plurality of clusters each having a reference position, and each to which a group of vectors close to the reference position belongs. The approximate nearest neighbor search method manages graph-based index information for defining an inter-cluster graph including a plurality of nodes respectively corresponding to the plurality of clusters and a plurality of edges each connecting nodes that respectively correspond to clusters having reference positions close to each other. The approximate nearest neighbor search method receives a query vector including a feature value for each of the plurality of dimensions. The approximate nearest neighbor search method executes a first process of determining, as a search start cluster, a cluster having a reference position closest to the query vector among the plurality of clusters. The approximate nearest neighbor search method searches for a vector closest to the query vector from vectors belonging to the search start cluster, as a nearest neighbor vector in the search start cluster. The approximate nearest neighbor search method selects one or more search target clusters close to the search start cluster while traversing the inter-cluster graph, and searches for a vector closest to the query vector from vectors belonging to each of the one or more search target clusters, as a nearest neighbor vector in each search target cluster. The approximate nearest neighbor search method outputs a vector closest to the query vector among the nearest neighbor vector searched for from the search start cluster and the nearest neighbor vectors searched for from the one or more search target clusters, as an approximate nearest neighbor vector of the query vector.

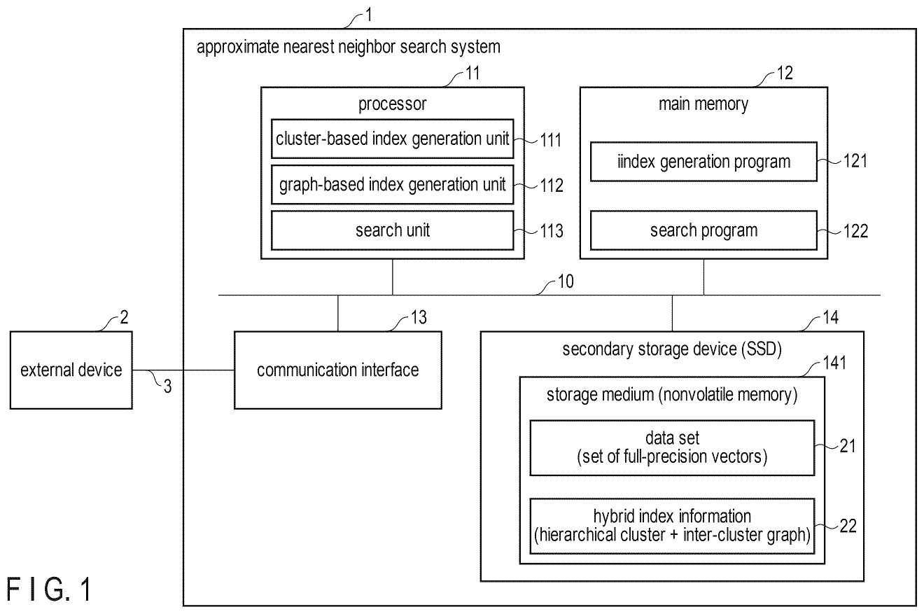

FIG. 1 is a block diagram illustrating a configuration example of an approximate nearest neighbor search system 1 according to an embodiment. The approximate nearest neighbor search system 1 is a computer system configured to perform an approximate nearest neighbor search on a vector database.

The vector database is a database that stores and manages a data set 21. The data set 21 includes a plurality of vectors. Each of the plurality of vectors is a non-compressed vector, that is, a full-precision vector.

Each of the plurality of vectors in the data set 21 includes a plurality of feature values respectively corresponding to a plurality of dimensions. Assuming that the number of dimensions of each vector is D, each vector (D-dimensional vector) corresponds to a point (data point) in a D-dimensional space. Each of D elements included in the D-dimensional vector represents a feature value (real number) for each of D attributes. Each vector is a high-dimensional vector whose number of dimensions D is several hundred or several thousand. The number of dimensions D may be, for example, 1024 or 2048. Hereinafter, a D-dimensional space is also referred to as a data space or a vector space.

The approximate nearest neighbor search system 1 receives a query vector which is based on a query from an external device 2. The query vector represents target data (target vector) to be searched for from a vector database. The query vector has the same number of dimensions D as the number of dimensions D of each vector in the vector database. That is, similarly to each vector in the vector database, the query vector also includes D feature values corresponding to the D dimensions. Hereinafter, a query vector is also simply referred to as a query.

The approximate nearest neighbor search system 1 performs approximate nearest neighbor search from the vector database based on the received query. The approximate nearest neighbor search is a search method of searching for a vector (approximate nearest neighbor vector) sufficiently close to a query for a certain distance scale at a high speed.

In the present embodiment, for example, a Euclidean distance is used as a distance measure for representing a distance between vectors. In this case, basically, for each of several search target vectors in all vectors in the vector database, a Euclidean distance to the query (query vector) is calculated, and a vector having the shortest Euclidean distance to the query among the search target vectors is found as an approximate nearest neighbor vector of the query.

The distance measure is not limited to the Euclidean distance, and any other distance capable of representing the distance between vectors may be used as the distance measure.

Next, a configuration of the approximate nearest neighbor search system 1 will be described. The approximate nearest neighbor search system 1 includes a processor 11, a main memory 12, a communication interface 13, and a secondary storage device 14. The processor 11, the main memory 12, the communication interface 13, and the secondary storage device 14 are connected to each other via a bus 10.

The processor 11 is, for example, a central processing unit (CPU). The processor 11 is able to access the main memory 12 and the secondary storage device 14. The processor 11 executes various processes including generation of index information 22 (here, hybrid index information 22), storage of the index information 22 in the secondary storage device 14, and search for a data set 21 by executing a computer program (here, an index generation program 121 and a search program 122) stored in the main memory 12. The hybrid index information 22 is a data structure used to search the data set 21 for a target vector (the approximate nearest neighbor vector of the query).

The main memory 12 is a memory device having low access latency such as a DRAM. The storage area of the main memory 12 is used as an area for storing a program to be executed by the processor 11 and a work area of the processor 11.

The communication interface 13 is a communication device. The communication interface 13 performs communication with the external device 2 via a communication path 3 such as a network or a bus, for example.

The secondary storage device 14 is a storage device having a capacity larger than the main memory 12 and an access speed lower than the main memory 12.

The approximate nearest neighbor search system 1 targets realization of a trillion-scale vector database capable of storing and managing a data set 21 including one trillion or more vectors. In a case where a trillion-scale vector database is constructed, the size of the data set 21 and the size of the index information 22 increase, and thus it is difficult to store the index information 22 in the main memory 12. Therefore, in the approximate nearest neighbor search system 1, each of the data set 21 and the index information 22 is stored in a storage medium 141 of the secondary storage device 14.

The secondary storage device 14 may be realized by a hard disk drive (HDD) or a solid state drive (SSD). Hereinafter, it is assumed that the secondary storage device 14 is realized by an SSD.

The SSD is a memory system including a non-volatile memory and a controller configured to control the non-volatile memory.

The non-volatile memory includes a plurality of blocks (also referred to as a “memory block”, “physical block”, or “flash block”) each of which is a unit of a data erasing operation. Each of the plurality of blocks includes a plurality of pages each of which is a unit of a data writing operation and a data reading operation. The non-volatile memory is, for example, a NAND flash memory. The NAND flash memory is, for example, a flash memory having a three-dimensional structure.

The controller is a memory controller having a circuit, and is realized as, for example, an LSI such as a system-on-a-chip (SoC).

The processor 11 functions as a cluster-based index generation unit 111, a graph-based index generation unit 112, and a search unit 113 by executing the index generation program 121 and the search program 122. Each of the cluster-based index generation unit 111, the graph-based index generation unit 112, and the search unit 113 may be realized by dedicated hardware (circuit) in the approximate nearest neighbor search system 1.

The cluster-based index generation unit 111 generates and manages a plurality of clusters. Each of the plurality of clusters has a reference position. The reference position of each cluster is represented by a vector having the same number of dimensions as the number of dimensions of each vector in the data set 21. In other words, the reference position of the cluster corresponds to one point in the data space (D-dimensional vector space) similarly to each vector in the data set 21, and is represented by a D-dimensional vector. Therefore, hereinafter, the reference position of each cluster is also referred to as a reference vector of each cluster.

A group of vectors close to the reference position belongs to each of a plurality of clusters. The number of vectors belonging to one cluster is, for example, N. In constructing a trillion-scale vector database, N may be, for example, 256. A relationship between each cluster and a group of vectors belonging to each cluster is determined as follows.

For example, it is assumed that a cluster X having a reference position x, a cluster Y having a reference position y, and a cluster Z having a reference position z are managed.

In this case, each of vectors close to the reference position x is managed to belong to the cluster X, each of vectors close to the reference position y is managed to belong to the cluster Y, and each of vectors close to the reference position z is managed to belong to the cluster Z.

A distance from each of vectors belonging to a certain cluster to the reference position of the cluster is shorter than a distance from each of these vectors to the reference position of each of the other clusters. That is, each vector in the data set 21 belongs to a cluster having the shortest distance from the vector to the reference position.

As the reference position of each cluster, for example, any one of the vectors belonging to the cluster can be used. In this case, the reference position of each cluster corresponds to a representative point of a plurality of data points corresponding to a plurality of vectors belonging to the cluster, and is also referred to as a cluster center.

The cluster-based index generation unit 111 generates cluster-based index information for defining a plurality of clusters each having a reference position (reference vector), and manages the generated cluster-based index information.

The cluster-based index information includes a belonging vector list for each of a plurality of clusters. The belonging vector list corresponding to a certain cluster indicates an identifier of each vector belonging to the cluster.

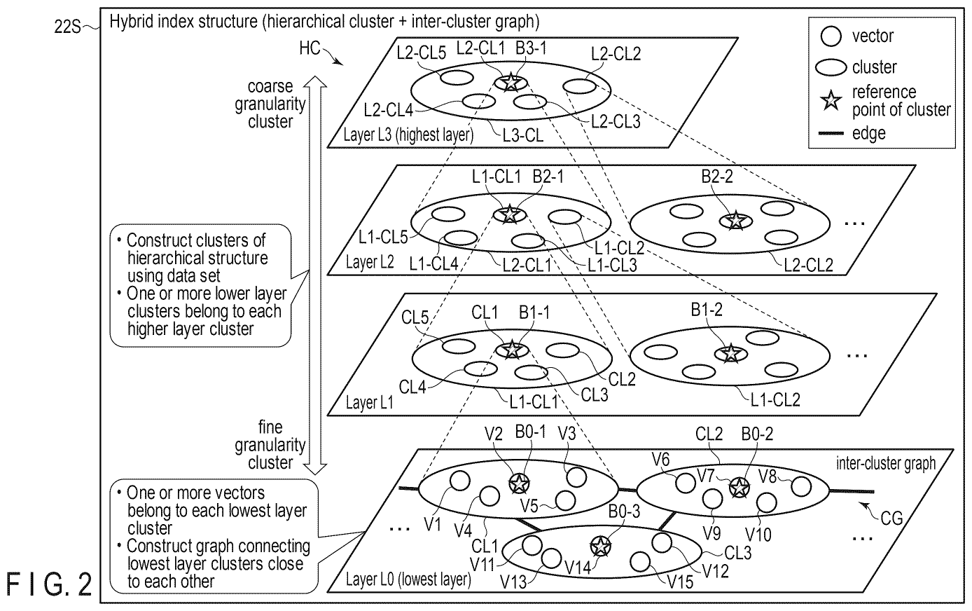

In the present embodiment, in order to reduce the calculation amount and time required to search for the approximate nearest neighbor vector of the query among one trillion or more vectors, a plurality of clusters may be managed as a hierarchical cluster. In this case, the cluster-based index information includes information for managing a plurality of clusters as a hierarchical cluster having a hierarchized cluster structure. Details of the hierarchical cluster will be described later with reference to FIG. 2 and subsequent drawings.

The graph-based index generation unit 112 generates graph-based index information and manages the generated graph-based index information. The graph-based index information includes information for defining an inter-cluster graph.

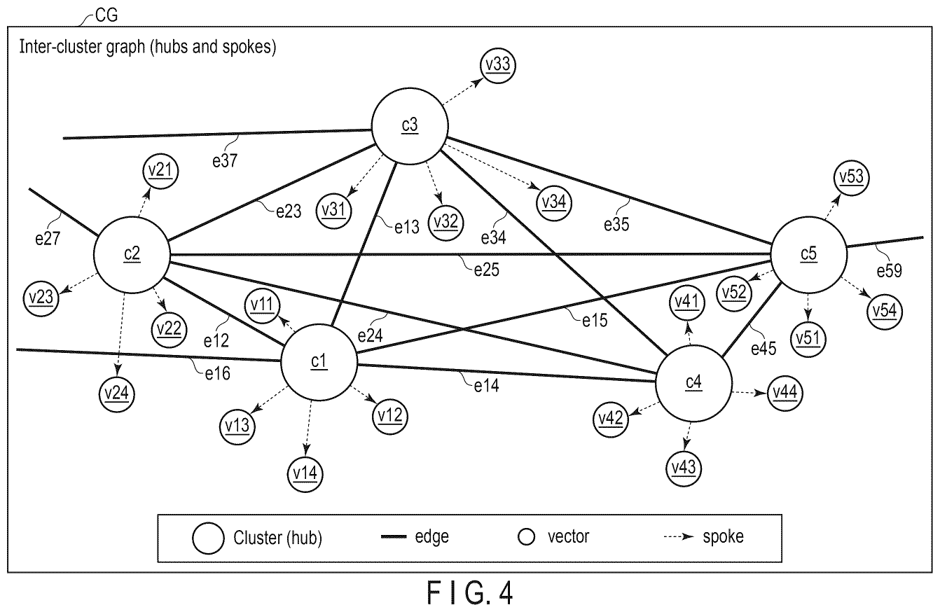

The inter-cluster graph is not a graph connecting vectors close to each other but a graph linking clusters close to each other. That is, the inter-cluster graph includes a plurality of nodes respectively corresponding to a plurality of clusters and a plurality of edges for connecting nodes respectively corresponding to clusters each having a reference position close to each other. Details of the structure of the inter-cluster graph will be described with reference to FIG. 4.

The search unit 113 receives a query vector which is based on a query from the external device 2 and performs approximate nearest neighbor search from the vector database. In the approximate nearest neighbor search, the search unit 113 searches for the approximate nearest neighbor vector of the query from the data set 21 by using the hybrid index information 22 including the cluster-based index information and the graph-based index information.

Next, a hybrid index structure including a hierarchical cluster HC and an inter-cluster graph CG will be described. FIG. 2 is a diagram illustrating an example of a hybrid index structure 22S.

The hierarchical cluster HC includes a plurality of layers. The plurality of layers include a lowest layer and a plurality of higher layers. FIG. 2 illustrates, as an example, a case where the lowest layer is a layer L0 and the plurality of higher layers include a layer L1, a layer L2, and a layer L3.

The lowest layer L0 includes a plurality of lowest layer clusters. A group of vectors close to the reference position thereof belongs to each of the plurality of lowest layer clusters. The plurality of clusters described above correspond to the plurality of lowest layer clusters included in the lowest layer L0, respectively.

FIG. 2 illustrates, as an example, only three lowest layer clusters CL1, CL2, and CL3 in the lowest layer L0. In practice, the lowest layer L0 may include lowest layer clusters of which the number is a value obtained by dividing the number of vectors in the data set 21 by N (number of vectors per cluster). FIG. 2 illustrates a case where N is 5 as an example, and a finite natural number other than 5 may be used.

Vectors V1 to V5 belong to the lowest layer cluster CL1. Each of the vectors V1 to V5 is a vector close to a reference position B0-1 of the lowest layer cluster CL1. The reference position (reference vector) B0-1 of the lowest layer cluster CL1 may be set to coincide with one (here, the vector V2) of the vectors V1 to V5.

Vectors V6 to V10 belong to the lowest layer cluster CL2. Each of the vectors V6 to V10 is a vector close to a reference position B0-2 of the lowest layer cluster CL2. The reference position (reference vector) B0-2 of the lowest layer cluster CL2 may be set to coincide with one (here, the vector V7) of the vectors V6 to V10.

Vectors V11 to V15 belong to the lowest layer cluster CL3. Each of the vectors V11 to V15 is a vector close to a reference position B0-3 of the lowest layer cluster CL3. The reference position (reference vector) B0-3 of the lowest layer cluster CL3 may be set to coincide with one (here, the vector V14) of the vectors V11 to V15.

Among these lowest layer clusters, two lowest layer clusters having reference positions close to each other are connected to each other by an edge of the inter-cluster graph CG. In FIG. 2, the edge is represented by a thick line.

N (here, five) lowest layer clusters among the lowest layer clusters are grouped into a set, and belong to one higher layer cluster among a plurality of higher layer clusters included in the layer L1 above one layer from the lowest layer.

FIG. 2 illustrates, as an example, only two higher layer clusters L1-CL1 and L1-CL2 among the plurality of higher layer clusters included in the layer L1. The higher layer clusters L1-CL1 and L1-CL2 have reference positions B1-1 and B1-2, respectively.

For example, the lowest layer clusters CL1 to CL5 belong to the higher layer cluster L1-CL1. The lowest layer clusters CL1 to CL5 are referred to as lower layer clusters of the higher layer cluster L1-CL1. Each of the lowest layer clusters CL1 to CL5 is a lowest layer cluster having a reference position close to the reference position B1-1 of the higher layer cluster L1-CL1. The reference position (reference vector) B1-1 of the higher layer cluster L1-CL1 may be set to coincide with the reference position of one of the lowest layer clusters CL1 to CL5 (here, the lowest layer cluster CL1).

N (here, five) higher layer clusters among the plurality of higher layer clusters included in the layer L1 are grouped into a set, and belong to one higher layer cluster among a plurality of higher layer clusters included in the layer L2.

FIG. 2 illustrates, as an example, only two higher layer clusters L2-CL1 and L2-CL2 among the plurality of higher layer clusters included in the layer L2. The higher layer clusters L2-CL1 and L2-CL2 have reference positions B2-1 and B2-2, respectively.

For example, the higher layer clusters L1-CL1 to L1-CL5 of the layer L1 belong to the higher layer cluster L2-CL1, as the lower layer clusters of the higher layer cluster L2-CL1. Each of the higher layer clusters L1-CL1 to L1-CL5 of the layer L1 has a reference position close to the reference position B2-1 of the higher layer cluster L2-CL1 of the layer L2. The reference position (reference vector) B2-1 of the higher layer cluster L2-CL1 of the layer L2 may be set to coincide with the reference position of one of the higher layer clusters L1-CL1 to L1-CL5 (here, the higher layer cluster L1-CL1).

The N (here, five) higher layer clusters included in the layer L2 above one layer from the layer L1 are grouped into a set and belong to one higher layer cluster (highest layer cluster) L3-CL included in the layer L3 (highest layer).

The higher layer clusters L2-CL1 to L2-CL5 of the layer L2 belong to the highest layer cluster L3-CL as a lower layer cluster of the highest layer cluster L3-CL. Each of the higher layer clusters L2-CL1 to L2-CL5 of the layer L2 has a reference position close to a reference position B3-1 of the highest layer cluster L3-CL. The reference position (reference vector) B3-1 of the highest layer cluster L3-CL may be set to coincide with the reference position of one of the higher layer clusters L2-CL1 to L2-CL5 (here, the higher layer cluster L2-CL1).

As described above, the hierarchical cluster HC has a structure in which a plurality of lower layer clusters each having the reference position close to the reference position thereof belongs to the higher layer cluster (highest layer cluster) L3-CL of the highest layer L3, and a plurality of lower layer clusters each having the reference position close to the reference position thereof also belong to each of the higher layer clusters of the higher layers L1 and L2. A plurality of clusters each to which a group of vectors belongs are managed by using a hierarchized cluster structure including the lowest layer and a plurality of higher layers.

The number of lower layer clusters belonging to each higher layer cluster may be changed by addition or deletion of the lower layer cluster. The higher layer cluster to which the number of belonging lower layer clusters becomes zero may be deleted. Therefore, one or more lower layer clusters belong to each higher layer cluster. In addition, the number of vectors belonging to each of the lowest layer clusters is changed by adding a vector to the data set 21 or deleting a vector from the data set 21. The lowest layer cluster to which the number of belonging vectors becomes zero may be deleted. Therefore, one or more vectors belong to each lowest layer cluster.

Next, a case of constructing a trillion-scale vector database is assumed. In this case, N may be set to several hundred, for example, 256.

256 vectors V belong to each of the lowest layer clusters CL of the lowest layer L0.

256 lowest layer clusters CL each including the 256 vectors V belong to one higher layer cluster L1-CL in the layer L1 as the lower layer cluster thereof. Thus, the number of vectors V that can be managed by each higher layer cluster L1-CL in the layer L1 is 256².

256 higher layer clusters L1-CL each including 256 lower layer clusters (256 lowest layer clusters CL) belong to one higher layer cluster L2-CL in the layer L2 as the lower layer cluster thereof. Thus, the number of vectors that can be managed by each higher layer cluster L2-CL in the layer L2 is 256³.

256 higher layer clusters L2-CL each including 256 lower layer clusters (256 higher layer clusters L1-CL) belong to one higher layer cluster L3-CL in the layer L3 as the lower layer cluster thereof. Thus, the number of vectors that can be managed by one higher layer cluster L3-CL in the layer L3 is 256⁴.

As described above, each time a level of the layer is increased by one level, the total number of manageable vectors increases by a factor of 256 (=2⁸). Thus, by setting the total number of layers included in the hierarchical cluster HC to the number corresponding to the scale of the vector database as a construction target, it is possible to construct a large-scale vector database exceeding the trillion scale. For example, in a case where the total number of layers is set to 8, the maximum of 2⁶⁴ (=2^{8×8}) vectors can be managed.

The hybrid index information 22 corresponding to the hierarchical cluster HC illustrated in FIG. 2 may include, for each higher layer cluster, for example, (1) a lower layer cluster list indicating an identifier of each of the lower layer clusters belonging to the higher layer cluster, (2) relative position information (first relative position information) indicating a positional relationship between the reference position of the higher layer cluster and the reference position of each of the lower layer clusters belonging to the higher layer cluster, and (3) relative position information (second relative position information) indicating a positional relationship between the reference position of the higher layer cluster and the reference position of each of the same layer clusters corresponding to the higher layer cluster. Here, the same layer cluster corresponding to a certain higher layer cluster is another cluster included in the same layer as the layer including this higher layer cluster.

The first relative position information may include, for example, any one or both of distance information indicating a distance between the reference position of the higher layer cluster and the reference position of each lower layer cluster and direction information indicating a direction from the reference position of the higher layer cluster to the reference position of each lower layer cluster.

The second relative position information may include, for example, any one or both of distance information indicating a distance between the reference position of the higher layer cluster and the reference position of each of the same layer clusters and direction information indicating a direction from the reference position of the higher layer cluster to the reference position of each of the same layer clusters.

The relative position information (the first relative position information and the second relative position information) is information acquired by pre-calculation. By using the relative position information (the first relative position information and the second relative position information), it is possible to efficiently search for a cluster having a reference position closest to the query from a plurality of lower layer clusters belonging to the higher layer cluster. Details of a search process using the relative position information (the first relative position information and the second relative position information) will be described later.

The hybrid index information 22 corresponding to the hierarchical cluster HC may further include, for each lowest layer cluster, for example, (1) a belonging vector list indicating an identifier of each vector belonging to the lowest layer cluster, (2) relative position information (third relative position information) indicating a positional relationship between the reference position of the lowest layer cluster and the reference position of each of the same layer clusters corresponding to the lowest layer cluster, (3) relative position information (fourth relative position information) indicating a positional relationship between the reference position of the lowest layer cluster and each vector belonging to the lowest layer cluster, (4) relative position information (fifth relative position information) indicating a positional relationship between each vector belonging to the lowest layer cluster and each other vector in the lowest layer cluster, (5) a neighbor list indicating an identifier of each neighbor cluster connected to the lowest layer cluster by an edge, and (6) relative position information (sixth relative position information) indicating a positional relationship between the reference position of the lowest layer cluster and the reference position of each neighbor cluster corresponding to the lowest layer cluster.

The third relative position information may include any one or both of distance information indicating a distance between the reference position of the lowest layer cluster and the reference position of each of the same layer clusters and direction information indicating a direction from the reference position of the lowest layer cluster to the reference position of each of the same layer clusters.

The fourth relative position information may include any one or both of distance information indicating a distance between the reference position of the lowest layer cluster and each vector and direction information indicating a direction from the reference position of the lowest layer cluster to each vector.

The fifth relative position information is information indicating a relative position between vectors belonging to the same lowest layer cluster, and may include any one or both of distance information indicating a distance between a vector and each other vector and direction information indicating a direction from the vector to each other vector.

The sixth relative position information may include any one or both of distance information indicating a distance between the reference position of the lowest layer cluster and the reference position of each neighbor cluster corresponding to the lowest layer cluster and direction information indicating a direction from the reference position of the lowest layer cluster to the reference position of each neighbor cluster corresponding to the lowest layer cluster.

The pieces of relative position information (the third relative position information, the fourth relative position information, the fifth relative position information, and the sixth relative position information) are information obtained by pre-calculation. By using these pieces of relative position information, it is possible to efficiently search for the lowest layer cluster having the reference position closest to the query from the lowest layer clusters belonging to a certain higher layer cluster of the layer L1, and it is possible to efficiently search for the vector closest to the query among the vectors belonging to each lowest layer cluster as the search target. Details of the search process using the pieces of relative position information will be described later.

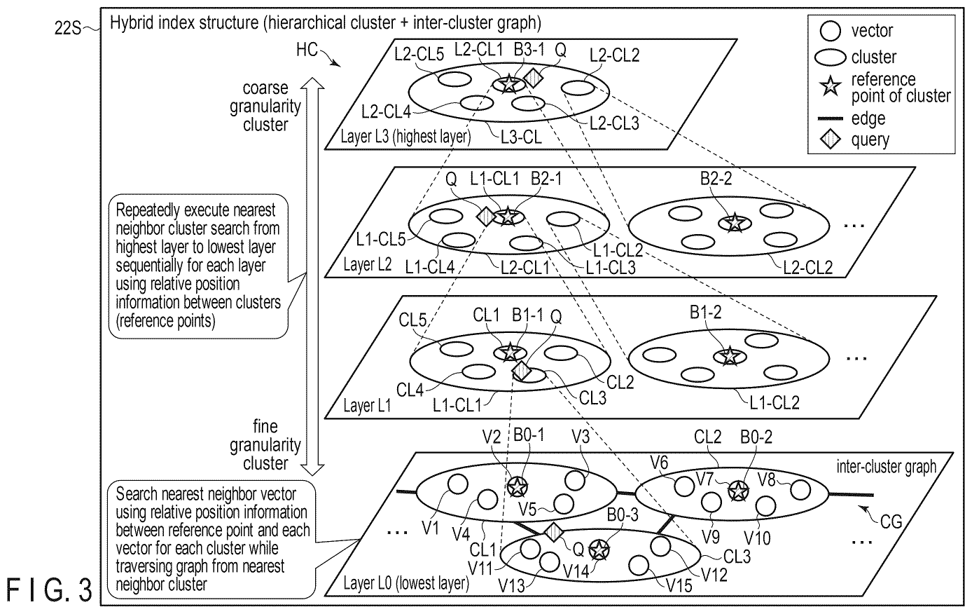

Next, an example of the search process using the hierarchical cluster HC and the inter-cluster graph CG will be described. FIG. 3 is a diagram illustrating an example of the search process executed in the approximate nearest neighbor search system 1 by using the hybrid index structure 22S.

In response to reception of a query vector Q (hereinafter, referred to as a query Q) which is based on a query from the external device 2, the processor 11 starts a search process for searching for an approximate nearest neighbor vector of the query Q from the data set 21.

This search process includes (1) an approximate nearest neighbor cluster search process for searching for a lowest layer cluster (approximate nearest neighbor cluster) having a reference position closest to the query Q, and (2) an approximate nearest neighbor vector search process for searching for an approximate nearest neighbor vector of the query Q from a group of vectors belonging to the approximate nearest neighbor cluster and a group of vectors belonging to each of one or more lowest layer clusters close to the approximate nearest neighbor cluster.

The approximate nearest neighbor cluster search process starts from the highest layer L3.

The processor 11 sets the highest layer cluster L3-CL as a target cluster of the approximate nearest neighbor cluster search process. The processor 11 finds a lower layer cluster having a reference position closest to the query Q from the lower layer clusters (here, the higher layer clusters L2-CL1 to L2-CL5 of the layer L2) belonging to the highest layer cluster L3-CL. In FIG. 3, among the lower layer clusters belonging to the highest layer cluster L3-CL (the higher layer clusters L2-CL1 to L2-CL5 of the layer L2), the lower layer cluster having the reference position with the shortest distance to the query Q is the higher layer cluster L2-CL1. Thus, the higher layer cluster L2-CL1 is found as the lower layer cluster that belongs to the highest layer cluster L3-CL and has the reference position closest to the query Q.

When the higher layer cluster L2-CL1 is found as the lower layer cluster that belongs to the highest layer cluster L3-CL and has the reference position closest to the query Q, the processor 11 sets the higher layer cluster L2-CL1 as a new target cluster. The processor 11 finds the lower layer cluster having the reference position closest to the query Q from lower layer clusters (here, the higher layer clusters L1-CL1 to L1-CL5 of the layer L1) belonging to the higher layer cluster L2-CL1. In FIG. 3, among the lower layer clusters belonging to the higher layer cluster L2-CL1 (the higher layer clusters L1-CL1 to L1-CL5 of the layer L1), the lower layer cluster having the reference position with the shortest distance to the query Q is the higher layer cluster L1-CL1. Thus, the higher layer cluster L1-CL1 is found as the lower layer cluster that belongs to the higher layer cluster L2-CL1 and has the reference position closest to the query Q.

When the higher layer cluster L1-CL1 is found as the lower layer cluster that belongs to the higher layer cluster L2-CL1 and has the reference position closest to the query Q, the processor 11 sets the higher layer cluster L1-CL1 as a new target cluster. The processor 11 finds the lower layer cluster having the reference position closest to the query Q from lower layer clusters (here, the lowest layer clusters CL1 to CL5 of the layer L0) belonging to the higher layer cluster L1-CL1. In FIG. 3, among the lower layer clusters belonging to the higher layer cluster L1-CL1 (the lowest layer clusters CL1 to CL5 of the layer L0), the lower layer cluster having the reference position with the shortest distance to the query Q is the lowest layer cluster CL3. Thus, the lowest layer cluster CL3 is found as the lower layer cluster that belongs to the higher layer cluster L1-CL1 and has the reference position closest to the query Q. The lowest layer cluster CL3 is determined as an approximate nearest neighbor cluster, that is, a search start cluster for the approximate nearest neighbor vector search process.

As described above, in the approximate nearest neighbor cluster search process using the hierarchical cluster HC, the search process for finding the lower layer cluster having the reference position closest to the query Q for each layer is repeatedly executed until one of the plurality of lowest layer clusters CL is found as the lower layer cluster having the reference position closest to the query Q. The lowest layer cluster having the reference position closest to the query Q among the plurality of lowest layer clusters CL is determined as an approximate nearest neighbor cluster (search start cluster). Note that, as a method of determining a search start cluster, for example, a method other than the method using the hierarchical cluster HC, such as a method using full search of clusters, a method using Locality Sensitive Hash (LSH), and a method using a hierarchized graph, may be used.

When the lowest layer cluster CL3 is determined as an approximate nearest neighbor cluster (search start cluster), the processor 11 performs search for the search start cluster (here, the lowest layer cluster CL3), and finds a vector closest to the query Q among the vectors V11 to V15 belonging to the lowest layer cluster CL3 as the nearest neighbor vector in the search start cluster (the lowest layer cluster CL3). In other words, the processor 11 searches for a vector closest to the query Q as the nearest neighbor vector in the search start cluster (the lowest layer cluster CL3) from the vectors V11 to V15 belonging to the search start cluster (here, the lowest layer cluster CL3).

Then, the processor 11 searches for one or more search target clusters (for example, the lowest layer clusters CL1, CL2, . . . ) close to the search start cluster (the lowest layer cluster CL3) while traversing the inter-cluster graph CG, and finds, for each of the one or more search target clusters, a vector closest to the query Q among vectors belonging to the search target cluster as the nearest neighbor vector in the search target cluster. In other words, the processor 11 selects one or more search target clusters while traversing the inter-cluster graph CG, and searches for the vector closest to the query Q from vectors belonging to each of the one or more search target clusters as the nearest neighbor vector in each search target cluster. In FIG. 3, the edge is represented by a thick line as in FIG. 2.

The processor 11 outputs, as a search result (approximate nearest neighbor vector), a vector closest to the query Q among the nearest neighbor vector found (searched) from the search start cluster (lowest layer cluster CL3) and the nearest neighbor vector found (searched) from each of the one or more search target clusters (for example, the lowest layer clusters CL1, CL2, . . . ). In this case, the search result (approximate nearest neighbor vector) is returned to the external device 2 as a response to the query Q.

The search process of finding the lower layer cluster having the reference position closest to the query Q for each higher layer can be executed as follows, by using the relative position information (for example, the first relative position information and the second relative position information) acquired by pre-calculation.

(1) The processor 11 sets the highest layer cluster L3-CL as a target cluster, and finds the lower layer cluster (for example, the cluster L2-CL1) having the reference position closest to the query Q among lower layer clusters (the higher layer clusters L2-CL1 to L2-CL5 of the layer L2) belonging to the target cluster (highest layer cluster L3-CL) by using the first relative position information corresponding to the target cluster (highest layer cluster L3-CL) and the second relative position information corresponding to each of the lower layer clusters (the higher layer clusters L2-CL1 to L2-CL5 of the layer L2) belonging to the target cluster (highest layer cluster L3-CL). In other words, the processor 11 searches for the lower layer cluster (for example, the cluster L2-CL1) having the reference position closest to the query Q from the lower layer clusters (the higher layer cluster L2-CL1 to L2-CL5 of the layer L2) belonging to the target cluster (the highest layer cluster L3-CL) by using the first relative position information corresponding to the target cluster (the highest layer cluster L3-CL) and the second relative position information corresponding to each of the lower layer clusters (the higher layer clusters L2-CL1 to L2-CL5 of the layer L2) belonging to the target cluster (the highest layer cluster L3-CL).

(2) Then, the processor 11 sets the found lower layer cluster (cluster L2-CL1) as a new target cluster, and finds a lower layer cluster (for example, the cluster L1-CL1) having a reference position closest to the query among the lower layer clusters (the higher layer clusters L1-CL1 to L1-CL5 of the layer L1) belonging to the new target cluster (cluster L2-CL1) by using the first relative position information corresponding to the new target cluster (cluster L2-CL1) and the second relative position information corresponding to each of the lower layer clusters (the higher layer clusters L1-CL1 to L1-CL5 of the layer L1) belonging to the new target cluster (cluster L2-CL1). In other words, the processor 11 searches for the lower layer cluster (for example, the cluster L1-CL1) having the reference position closest to the query from the lower layer clusters (the higher layer clusters L1-CL1 to L1-CL5 of the layer L1) belonging to the new target cluster (cluster L2-CL1) by using the first relative position information corresponding to the new target cluster (cluster L2-CL1) and the second relative position information corresponding to each of the lower layer clusters (the higher layer clusters L1-CL1 to L1-CL5 of the layer L1) belonging to the new target cluster (cluster L2-CL1).

(3) The processor 11 repeatedly executes the process of (2) including a process of setting the found lower layer cluster as a new target cluster and a process of finding a lower layer cluster having a reference position closest to the query among the lower layer clusters belonging to the new target cluster until the found lower layer cluster reaches the lowest layer L0, that is, until one of the plurality of lowest layer clusters is searched for as the lower layer cluster having the reference position closest to the query.

When the found lower layer cluster reaches the lowest layer L0, the found lower layer cluster becomes the search start cluster of the lowest layer L0. The search process of finding the nearest neighbor vector in the search start cluster and the search process of finding the nearest neighbor vector in each search target cluster can be executed by using the relative position information (for example, the fourth relative position information and the fifth relative position information) obtained by pre-calculation.

For example, it is assumed that the lowest layer cluster CL3 is determined as the search start cluster. In this case, the processor 11 finds a vector closest to the query Q among the vectors V11 to V15 belonging to the lowest layer cluster CL3 by using the fourth relative position information indicating the positional relationship between the reference position B0-3 of the lowest layer cluster CL3 and each of the vectors V11 to V15 and the fifth relative position information indicating the positional relationship between the vectors V11 to V15.

Next, the configuration of the inter-cluster graph CG will be described. FIG. 4 is a diagram illustrating a configuration example of the inter-cluster graph CG used in the approximate nearest neighbor search system 1.

The inter-cluster graph CG is not a graph connecting vectors, but is a graph connecting clusters each to which a plurality of vectors belong. The inter-cluster graph CG can be realized by using, for example, a hub and spoke structure.

The hub and spoke structure includes a hub and some spokes extending from the hub. In an inter-cluster graph CG having the hub and spoke structure, clusters are represented by hubs. The individual vectors belonging to the cluster are respectively represented by individual spokes extending from the hub. The cluster (hub) corresponds to a node of the inter-cluster graph CG, and two clusters (two hubs) close to each other are connected by one edge.

In FIG. 4, clusters c1 to c5 are exemplified as the lowest layer clusters.

The cluster c1 has four spokes respectively corresponding to four vectors v11 to v14 belonging to the cluster c1. The four spokes of the cluster c1 are represented by a belonging vector list corresponding to the cluster c1 and the relative position information indicating a positional relationship between the reference position of the cluster c1 and each of the vectors v11 to v14. In FIG. 4, the spokes are indicated by dotted arrows.

The cluster c2 has four spokes respectively corresponding to four vectors v21 to v24 belonging to the cluster c2. The four spokes of the cluster c2 are represented by a belonging vector list corresponding to the cluster c2 and the relative position information indicating a positional relationship between the reference position of the cluster c2 and each of the vectors v21 to v24.

The cluster c3 has four spokes respectively corresponding to four vectors v31 to v34 belonging to the cluster c3. The four spokes of the cluster c3 are represented by a belonging vector list corresponding to the cluster c3 and the relative position information indicating a positional relationship between the reference position of the cluster c3 and each of the vectors v31 to v34.

The cluster c4 has four spokes respectively corresponding to four vectors v41 to v44 belonging to the cluster c4. The four spokes of the cluster c4 are represented by a belonging vector list corresponding to the cluster c4 and the relative position information indicating a positional relationship between the reference position of the cluster c4 and each of the vectors v41 to v44.

The cluster c5 has four spokes respectively corresponding to four vectors v51 to v54 belonging to the cluster c5. The four spokes of the cluster c5 are represented by a belonging vector list corresponding to the cluster c5 and the relative position information indicating a positional relationship between the reference position of the cluster c5 and each of the vectors v51 to v54.

The cluster c1 is connected to the cluster c2 by an edge e12, connected to the cluster c3 by an edge e13, connected to the cluster c4 by an edge e14, connected to the cluster c5 by an edge e15, and connected to another cluster (not illustrated) by an edge e16. These edges e12 to e16 are represented by a neighbor list corresponding to the cluster c1. In FIG. 4, the edge is represented by a thick line similarly to FIGS. 2 and 3.

The cluster c2 is connected to the cluster c1 by the edge e12, connected to the cluster c3 by an edge e23, connected to the cluster c4 by an edge e24, connected to the cluster c5 by an edge e25, and connected to another cluster (not illustrated) by an edge e27. These edges e12, e23 to e25, and e27 are represented by a neighbor list corresponding to the cluster c2.

The cluster c3 is connected to the cluster c1 by the edge e13, connected to the cluster c2 by the edge e23, connected to the cluster c4 by an edge e34, connected to the cluster c5 by an edge e35, and connected to another cluster (not illustrated) by an edge e37. These edges e13, e23, e34, e35, and e37 are represented by a neighbor list corresponding to the cluster c3.

The cluster c4 is connected to the cluster c1 by the edge e14, connected to the cluster c2 by the edge e24, connected to the cluster c3 by the edge e34, and connected to the cluster c5 by an edge e45. These edges e14, e24, e34, and e45 are represented by a neighbor list corresponding to the cluster c4.

The cluster c5 is connected to the cluster c1 by the edge e15, connected to the cluster c2 by the edge e25, connected to the cluster c3 by the edge e35, connected to the cluster c4 by the edge e45, and connected to another cluster (not illustrated) by an edge e59. These edges e15, e25, e35, e45, and e59 are represented by a neighbor list corresponding to the cluster c5.

Another cluster B connected to a certain cluster A by an edge is referred to as an neighbor cluster of the cluster A.

As described above, by using a graph connecting clusters instead of a graph connecting vectors, the number of edges in the graph can be significantly reduced. For example, in a case where up to 256 vectors can be registered in one cluster (hub), the number of edges in the graph can be reduced to 1/256. Thus, since the number of neighbor lists for representing edges in the graph can be reduced, an increase in the size of the index information can be minimized even in a case of constructing a large-scale vector database of the billion scale or more.

In addition, in the configuration using the inter-vector graph, it is necessary to rewrite a large number of neighbor lists (edge information) each time one vector is added to the vector database, but in the configuration using the graph connecting clusters, it is only necessary to register a new vector in one cluster (hub), and it is not necessary to rewrite the neighbor list (edge information). Therefore, the update frequency of the graph can be reduced, and, as a result, the amount of writing to the SSD 14 is reduced. Thus, the life of the SSD 14 can be extended, and the time required for registering one vector can be shortened.

The number of vectors that can be registered in each cluster (hub) is limited to an upper limit value. Therefore, it is necessary to generate a new cluster and rewrite the neighbor list (edge information) accompanying the generation of the new cluster at a low frequency. However, since the number of clusters (hubs) is considerably smaller than the number of vectors, adverse effects on the life of the SSD 14 are small.

In the present embodiment, the data set (a plurality of vectors) 21 and the hybrid index information 22 (the cluster-based index information and the graph-based index information) are stored in the secondary storage device 14 such as the SSD. In this case, the neighbor list included in the graph-based index information is stored in a storage area in the secondary storage device 14 different from the storage area in the secondary storage device 14 in which the data set (the plurality of vectors) 21 is stored.

For example, in the SSD, the neighbor list and the plurality of vectors are stored in different blocks in the non-volatile memory. Even if a new vector is added to the data set 21, it is not necessary to update each vector already stored in the secondary storage device 14. On the other hand, the neighbor list is updated when addition or deletion of a cluster is required with addition or deletion of a vector. Therefore, by storing the vector and the neighbor list in different storage areas such as blocks different from each other in the non-volatile memory, it is possible to rewrite only the neighbor list and maintain the vector without rewriting the vector, and it is possible to prevent deterioration of the write amplification of the SSD.

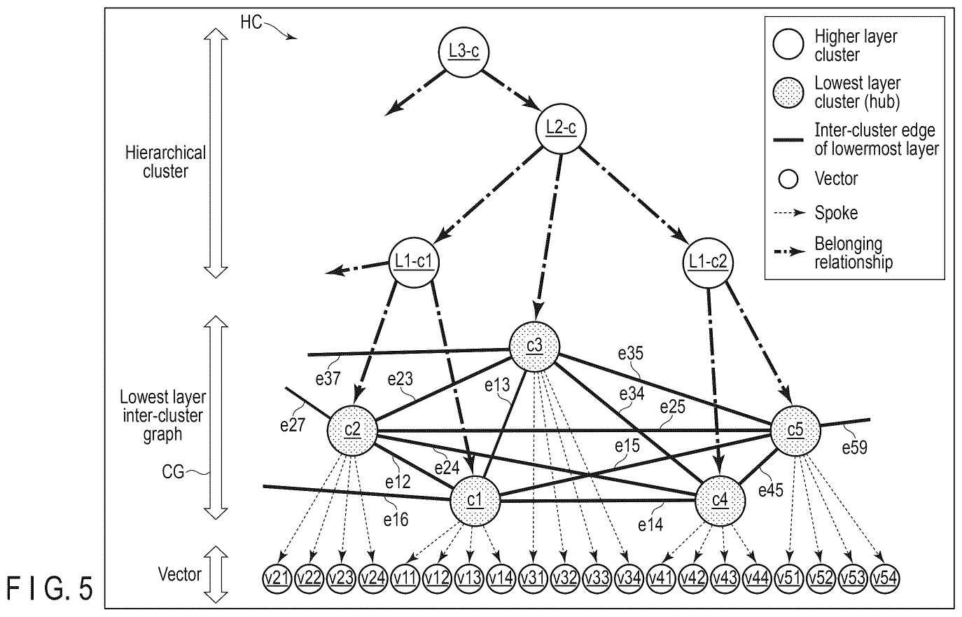

FIG. 5 is a diagram illustrating cluster search using the hierarchical cluster HC and approximate nearest neighbor vector search using the inter-cluster graph CG.

The processor 11 sets a highest layer cluster L3-c of the hierarchical cluster HC as the target cluster, and starts the search process from the highest layer cluster L3-c. The processor 11 finds one higher layer cluster L2-c having a reference position closest to a query among a plurality of higher layer clusters L2-c belonging to the highest layer cluster L3-c.

The processor 11 sets the found higher layer cluster L2-c as a new target cluster, and finds one higher layer cluster L1-c having a reference position closest to the query among a plurality of higher layer clusters L1-c1, L1-c2, . . . belonging to the found higher layer cluster L2-c.

The processor 11 sets the found higher layer cluster L1-c as a new target cluster, and finds one lowest layer cluster c having a reference position closest to the query among a plurality of lowest layer clusters c belonging to the found higher layer cluster L1-c, as an approximate nearest neighbor cluster (search start cluster). For example, in a case where the new target cluster is the higher layer cluster L1-c1, the processor 11 finds one lowest layer cluster having the reference position closest to the query among the lowest layer clusters c1, c2, . . . belonging to the higher layer cluster L1-c1, as the approximate nearest neighbor cluster (search start cluster). In a case where the new target cluster is the higher layer cluster L1-c2, the processor 11 finds one lowest layer cluster having the reference position closest to the query among the lowest layer clusters c4, c5, . . . belonging to the higher layer cluster L1-c2, as the approximate nearest neighbor cluster (search start cluster).

In the data space, there may be a range in which a large number of vectors v exist and a range in which a small number of vectors v exist. The lowest layer cluster located in the range in which the small number of vectors v exist may skip the layer L1 and belong to the higher layer cluster in the layer L2. In FIG. 5, the reference position of the lowest layer cluster c3 is set in the range in which the small number of vectors v exist, and the reference position of the higher layer cluster L2-c of the layer L2 is set in this range. In this case, the lowest layer cluster c3 may skip the layer L1 and directly belong to the higher layer cluster L2-c of the layer L2. In FIG. 5, a bold arrow of a dashed-dotted line indicates such a belonging relationship.

As described above, in the present embodiment, on the upper side of the inter-cluster graph CG, a plurality of higher layers of the hierarchical cluster HC is arranged instead of the graph. The processor 11 determines an approximate nearest neighbor cluster (search start cluster) by executing (1) a process of setting the highest layer cluster as a processing target cluster, (2) a process of finding a lower layer cluster having a reference position closest to the query among lower layer clusters belonging to the processing target cluster and setting the found lower layer cluster as a new processing target cluster, and (3) a process of repeating the process of (2) until the lowest layer cluster is found as the lower layer cluster having the reference position closest to the query.

In the lowest layer, first, a nearest neighbor vector in the search start cluster is found, and a distance from the nearest neighbor vector to the query is set as a provisional nearest neighbor distance.

For example, in a case where the lowest layer cluster c1 is determined as the approximate nearest neighbor cluster (search start cluster), the vector closest to the query among the vectors v11 to v14 is found as the nearest neighbor vector in the lowest layer cluster c1. The distance from the nearest neighbor vector in the lowest layer cluster c1 to the query is set as the provisional nearest neighbor distance. The distance from the nearest neighbor vector in the lowest layer cluster c1 to the query is, for example, a Euclidean distance between the nearest neighbor vector in the lowest layer cluster c1 and the query.

Since the lowest layer cluster c1 is the lowest layer cluster having the reference position closest to the query, it is also conceivable to use a method of determining the nearest neighbor vector in the lowest layer cluster c1 as the approximate nearest neighbor vector of the query.

However, normally, the location of the query in the data space is different from the reference position of the lowest layer cluster c1. Although the vectors v11 to v14 are a group of vectors close to the reference position of the lowest layer cluster c1, there is a difference between the distance from each of the vectors v11 to v14 to the query and the distance from each of the vectors v11 to v14 to the reference position of the lowest layer cluster c1. Therefore, there is not always a vector sufficiently close to the query in the vectors v11 to v14, and the vector sufficiently close to the query may belong to another lowest layer cluster existing close to the lowest layer cluster c1.

Therefore, in the approximate nearest neighbor vector search process of the present embodiment, a search process for one or more lowest layer clusters (search target clusters) close to the lowest layer cluster c1 is further executed while traversing the inter-cluster graph CG. In this case, for each of the one or more search target clusters, the vector closest to the query among vectors belonging to the search target cluster is found as the nearest neighbor vector in the search target cluster. Among the nearest neighbor vectors found from the lowest layer cluster c1 and the nearest neighbor vectors found from the one or more search target clusters, a vector closest to the query vector is output as the search result, that is, the approximate nearest neighbor vector of the query.

In the search process for each of the search start cluster and the search target cluster, the distance from the query to the vector may be calculated for all the vectors in the cluster, and the vector having the minimum distance may be selected as the nearest neighbor vector in the cluster. The search process for one or more lowest layer clusters (search target clusters) close to the lowest layer cluster c1 may be executed, for example, with the following procedure.

For example, the lowest layer cluster c1 is set as a base cluster serving as a starting point of the search process, and one or more neighbor clusters of the lowest layer cluster c1 are set as one or more search target clusters. In a case where a vector whose distance to the query is shorter than the provisional nearest neighbor distance is not found from any neighbor cluster among the one or more search target clusters, the search process may be ended. In this case, the provisional nearest neighbor distance is output as the approximate nearest neighbor vector of the query.

On the other hand, in a case where a vector whose distance to the query is shorter than the provisional nearest neighbor distance is found from a certain search target cluster cx among the one or more search target clusters, a distance (Euclidean distance) from the found vector to the query may be set as a new provisional nearest neighbor distance, and one or more neighbor clusters obtained by excluding the already searched cluster from the one or more neighbor clusters of the search target cluster cx may be set as one or more new search target clusters.

In a case where a vector whose distance to the query is shorter than the provisional nearest neighbor distance is not found from any neighbor cluster among the one or more new search target clusters, the search process may be ended. In this case, the new provisional nearest neighbor distance is output as the approximate nearest neighbor vector of the query.

In a case where a vector whose distance to the query is shorter than the provisional nearest neighbor distance is found from a certain search target cluster cy among the one or more new search target clusters, a distance (Euclidean distance) from the found vector to the query may be set as a further new provisional nearest neighbor distance, and one or more neighbor clusters obtained by excluding the already searched cluster from the one or more neighbor clusters of the search target cluster cy may be set as one or more further new search target clusters.

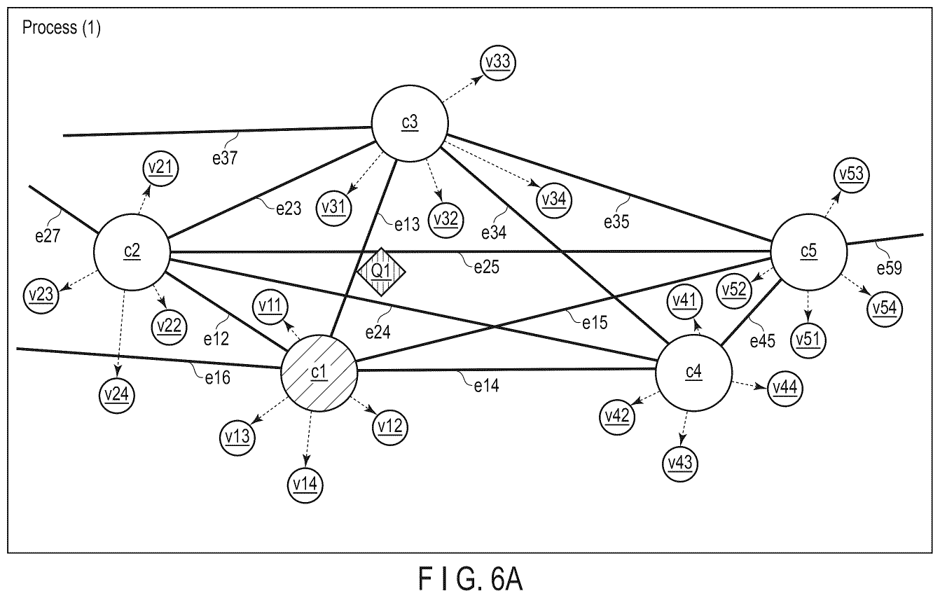

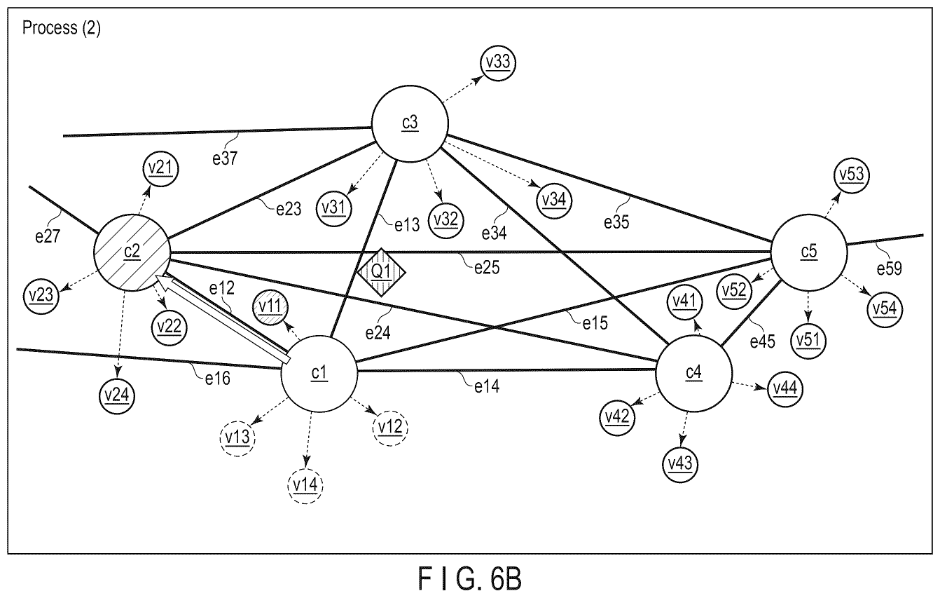

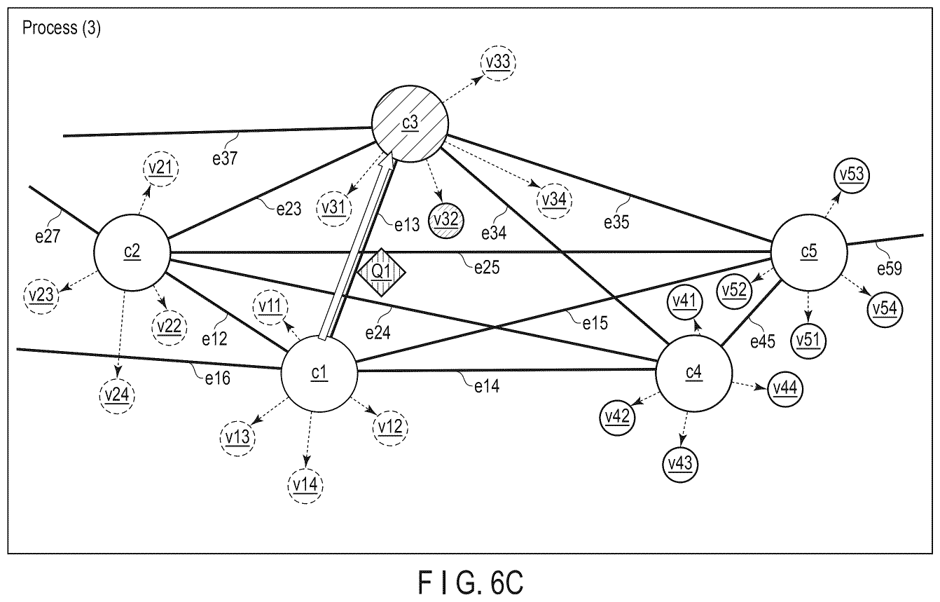

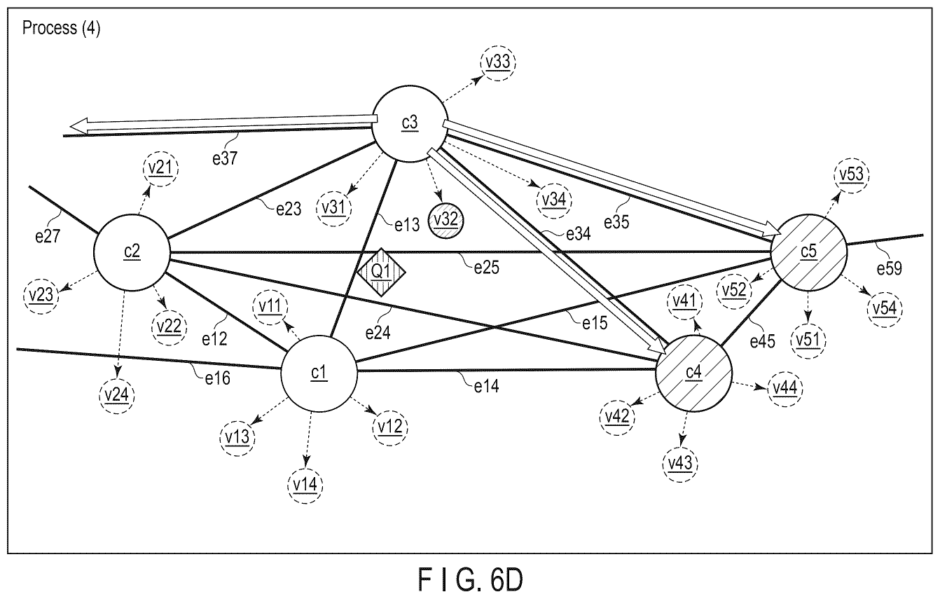

Next, an example of a procedure of the approximate nearest neighbor vector search process will be described with reference to FIGS. 6A to 6D. FIG. 6A is a diagram illustrating the search process for a search start cluster (here, the lowest layer cluster c1). FIG. 6B is a diagram illustrating the search process for a first search target cluster (here, the lowest layer cluster c2) closest to the search start cluster. FIG. 6C is a diagram illustrating the search process for a second search target cluster (here, the lowest layer cluster c3). FIG. 6D is a diagram illustrating the search process for one or more neighbor clusters obtained by excluding an already searched cluster from neighbor clusters of the second search target cluster (here, the lowest layer cluster c3).

(Process 1) As illustrated in FIG. 6A, the lowest layer cluster c1 having the reference position closest to a query Q1 is determined as a search start cluster, and the search process is started from the lowest layer cluster c1.

(Process 2) As illustrated in FIG. 6B, a vector (here, the vector v11) closest to the query Q1 is found among the vectors v11 to v14 belonging to the lowest layer cluster c1. That is, the vector v11 is the nearest neighbor vector in the lowest layer cluster c1. A distance from the vector v11 to the query Q1 is set as the provisional nearest neighbor distance. A vector whose distance to the query Q1 is shorter than the provisional nearest neighbor distance is highly likely to be found from a cluster having a reference position close to the reference position of the lowest layer cluster c1. Among the neighbor clusters of the lowest layer cluster c1 (here, the lowest layer clusters c2 to c5), the neighbor cluster closest to the reference position of the lowest layer cluster c1 is the lowest layer cluster c2. Therefore, by traversing the inter-cluster graph CG with the lowest layer cluster c1 as the base cluster, the search process for the lowest layer cluster c2 is executed next. A process of finding a vector whose distance to the query Q1 is shorter than the provisional nearest neighbor distance from the vectors v21 to v24 belonging to the lowest layer cluster c2 is executed.

(Process 3) In a case where a vector whose distance to the query Q1 is shorter than the provisional nearest neighbor distance is not found from the lowest layer cluster c2, a next search process for the next lowest layer cluster is executed. An neighbor cluster that is second closest to the lowest layer cluster c1 is the lowest layer cluster c3. Therefore, as illustrated in FIG. 6C, by traversing the inter-cluster graph CG with the lowest layer cluster c1 as the base cluster, a next search process for the lowest layer cluster c3 is executed. A process of finding a vector whose distance to the query Q1 is shorter than the provisional nearest neighbor distance from the vectors v31 to v34 belonging to the lowest layer cluster c3 is executed. Here, a distance from the vector v32 to the query Q1 is shorter than the provisional nearest neighbor distance. Therefore, the vector v32 is found as the vector whose distance to the query Q1 is shorter than the provisional nearest neighbor distance. A distance from the vector v32 to the query Q1 is set as a new provisional nearest neighbor distance.

(Process 4) As illustrated in FIG. 6D, the lowest layer cluster c3 is set as a new base cluster, and the search process is executed for all neighbor clusters (here, c4, c5, and the like) obtained by excluding the already searched cluster (here, c1 and c2) from the neighbor clusters (here, c1, c2, c4, c5, and the like) of the lowest layer cluster c3. In a case where a vector whose distance to the query Q1 is shorter than the new provisional nearest neighbor distance is not found from the neighbor clusters (here, c4, c5, and the like), the process is ended, and the vector v32 is determined as the approximate nearest neighbor vector of the query Q1.

As described above, in the approximate nearest neighbor vector search process, not only the process of finding the nearest neighbor vector in the search start cluster from among the vectors belonging to the lowest layer cluster c1 (search start cluster) having the reference position closest to the query Q1, but also search for one or more lowest layer clusters (search target clusters) close to the search start cluster is performed by traversing the inter-cluster graph CG, and the nearest neighbor vector in the search target cluster is found for each search target cluster. Therefore, not only the search start cluster but also each of neighbor clusters of the search start cluster is searched for. As a result, it is possible to realize high search accuracy equivalent to that of an approximate nearest neighbor search algorithm using an inter-vector graph that connects vectors, while greatly reducing the number of times of rewriting edge information.

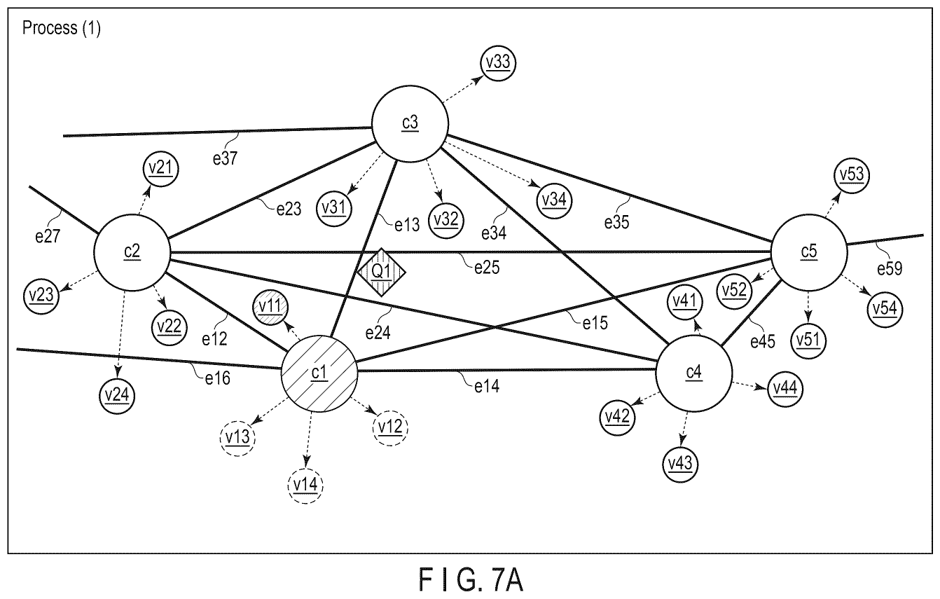

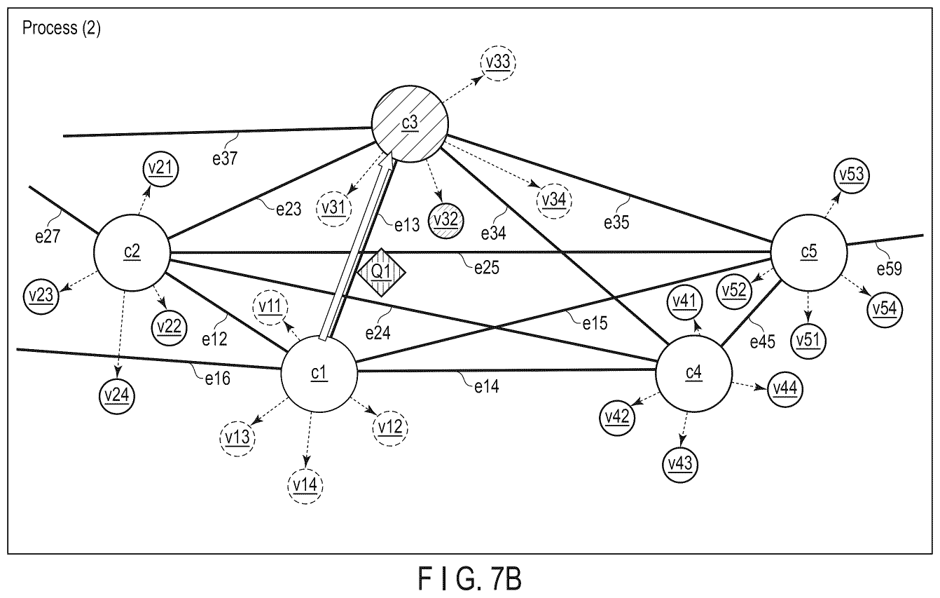

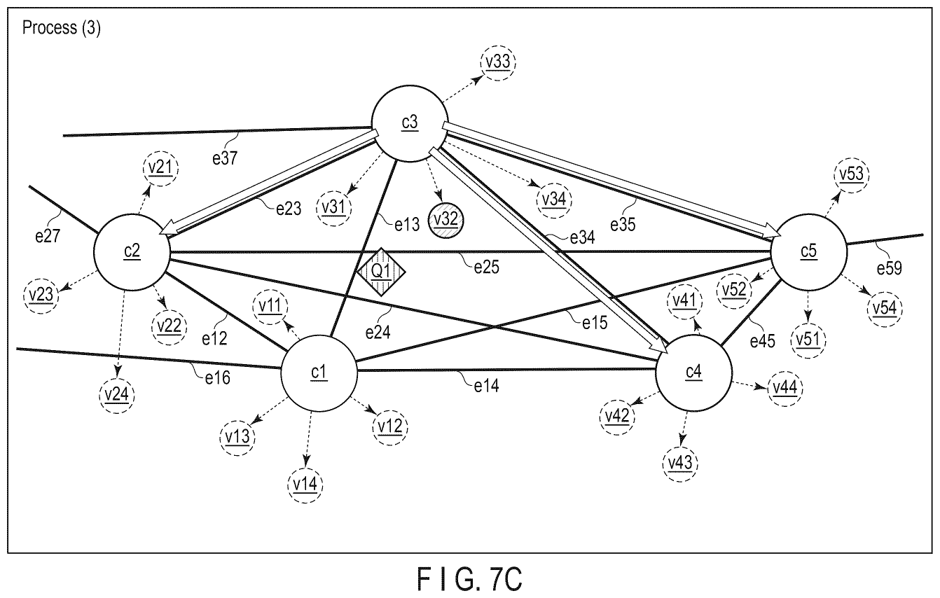

Next, another example of the procedure of the approximate nearest neighbor vector search process will be described with reference to FIGS. 7A to 7C. FIG. 7A is a diagram illustrating the search process for a search start cluster (here, the lowest layer cluster c1). FIG. 7B is a diagram illustrating the search process for a search target cluster (here, the lowest layer cluster c3) having a direction closest to a direction from a reference position of the search start cluster to a query. FIG. 7C is a diagram illustrating the search process for one or more neighbor clusters obtained by excluding an already searched cluster from neighbor clusters of the search target cluster (here, the lowest layer cluster c3) having a direction closest to a direction from a reference position of the search start cluster to the query.

In the approximate nearest neighbor vector search process illustrated in FIGS. 7A to 7C, it is assumed that the graph-based index information includes direction information indicating a direction from the reference position of the lowest layer cluster c1 to the reference position of the neighbor cluster for each of neighbor clusters (here, the lowest layer clusters c2 to c5) of the lowest layer cluster c1.

(Process 1) As illustrated in FIG. 7A, the lowest layer cluster c1 having the reference position closest to a query Q1 is determined as a search start cluster, and the search process is started from the lowest layer cluster c1. A vector (here, the vector v11) closest to the query Q1 is found among the vectors v11 to v14 belonging to the lowest layer cluster c1. That is, the vector v11 is the nearest neighbor vector in the lowest layer cluster c1. The distance from the vector v11 to the query Q1 is set as the provisional nearest neighbor distance.

(Process 2) The direction from the reference position of the lowest layer cluster c1 to the query Q1 is calculated.

This direction corresponds to, for example, the direction of a difference vector obtained by subtracting the reference position (reference vector) of the lowest layer cluster c1 from the query (query vector) Q1. Therefore, the direction from the reference position of the lowest layer cluster c1 to the query Q1 can be obtained by calculating the difference vector obtained by subtracting the reference position (reference vector) of the lowest layer cluster c1 from the query (query vector) Q1. Direction information obtained by further compressing the difference vector may be used as direction information indicating the direction from the reference position of the lowest layer cluster c1 to the query Q1. As a method of compressing the difference vector, a method of reducing the number of dimensions of the difference vector can be used. The direction information compressed by the reduction in the number of dimensions is also referred to as a direction hash. Each piece of direction information included in the hybrid index information 22 can also be represented by a dimensionally calculated direction hash.

There is a high possibility that the vector close to the query Q1 exists at a position corresponding to a direction similar to the direction of the query Q1 viewed from the reference position of the lowest layer cluster c1. Therefore, by using direction information corresponding to each of the lowest layer clusters c2 to c5, among the lowest layer clusters c2 to c5, the lowest layer cluster having a direction most similar to the direction from the reference position of the lowest layer cluster c1 to the query Q1 is selected as the next search target cluster with priority over other neighbor clusters. The lowest layer cluster having a direction most similar to the direction from the reference position of the lowest layer cluster c1 to the query Q1 is a cluster existing in a direction similar to the query Q1 when viewed from the reference position of the lowest layer cluster c1.

For example, the lowest layer cluster corresponding to direction information (direction hash) most similar to the direction information (direction hash) indicating the direction from the reference position of the lowest layer cluster c1 to the query Q1 may be selected as the next search target cluster with priority over other neighbor clusters. The similarity (degree of coincidence) between the direction hashes can be calculated by calculating a Hamming distance between the direction hashes.

In FIG. 7B, the lowest layer cluster having the direction most similar to the direction from the reference position of the lowest layer cluster c1 to the query Q1 is the lowest layer cluster c3. Therefore, the lowest layer cluster c3 is selected as the next search target cluster with priority over other neighbor clusters (c2, c4, c5, and the like). Therefore, as illustrated in FIG. 7B, by following the inter-cluster graph CG with the lowest layer cluster c1 as the base cluster, the search process for the lowest layer cluster c3 is executed next. The process of finding a vector whose distance to the query Q1 is shorter than the provisional nearest neighbor distance from the vectors v31 to v34 belonging to the lowest layer cluster c3 is executed. Here, the distance from the vector v32 to the query Q1 is shorter than the provisional nearest neighbor distance. Therefore, the vector v32 is found as the vector whose distance to the query Q1 is shorter than the provisional nearest neighbor distance. The distance from the vector v32 to the query Q1 is set as a new provisional nearest neighbor distance.

(Process 3) As illustrated in FIG. 7C, the lowest layer cluster c3 is set as a new base cluster, and the search process is executed for all neighbor clusters (here, c2, c4, c5, and the like) obtained by excluding the already searched cluster (here, c1) from the neighbor clusters (here, c1, c2, c4, c5, and the like) of the lowest layer cluster c3. In a case where a vector whose distance to the query Q1 is shorter than the new provisional nearest neighbor distance is not found from the neighbor clusters (here, c2, c4, c5, and the like), the process is ended, and the vector v32 is determined as the approximate nearest neighbor vector of the query Q1.

Next, a process of adding a new cluster to the inter-cluster graph will be described.

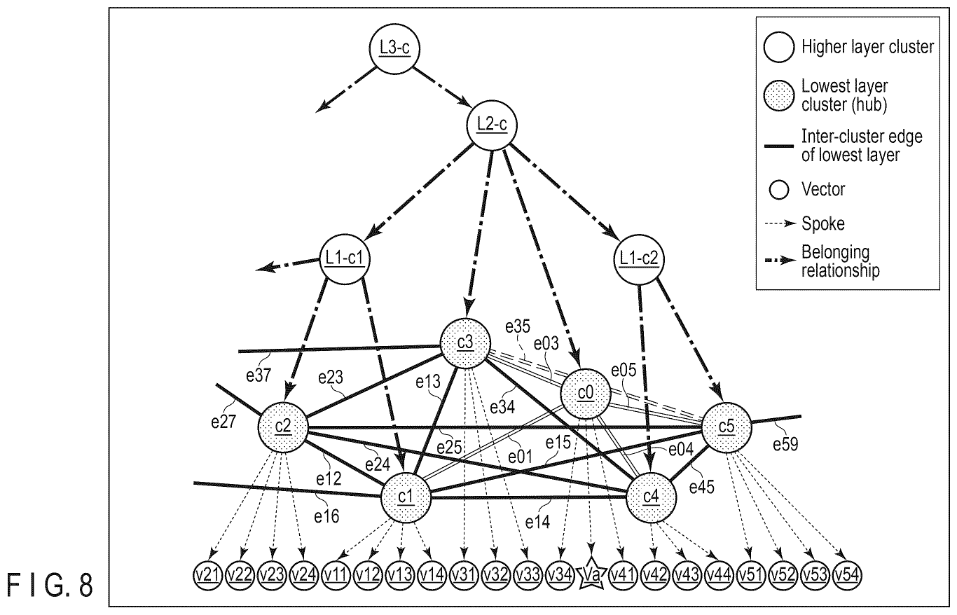

FIG. 8 is a diagram illustrating an index update process for adding a new cluster. As described above, when a new vector is added to the data set 21 of the vector database, a cluster having a reference position closest to the new vector is specified among existing clusters (existing lowest layer clusters), and the new vector is registered in the belonging vector list corresponding to the specified cluster.

In a case where the number of vectors belonging to the specified cluster exceeds the upper limit value due to the registration of the new vector, a new cluster is generated, and the generated cluster is added to the inter-cluster graph CG.

In FIG. 8, a case where a new vector Va is added to the data set 21 in the state of FIG. 5 is assumed. In addition, a case where a cluster (lowest layer cluster) having a reference position closest to the new vector Va is the lowest layer cluster c3 is assumed.

In the state of FIG. 5, four vectors v31 to v34 already belong to the lowest layer cluster c3. Therefore, in a case where the upper limit of the number of vectors that can belong to each cluster is, for example, 4, overflow of the lowest layer cluster c3 occurs due to the registration of the new vector Va.

Therefore, as illustrated in FIG. 8, a new cluster (new lowest layer cluster) c0 having a reference position close to the reference position of the lowest layer cluster c3 is generated. A cluster addition process of adding the lowest layer cluster c0 to the inter-cluster graph CG is executed. In the cluster addition process, the processor 11 executes the following process.

The processor 11 registers the identifier of the lowest layer cluster c3 and the identifier of each of the neighbor clusters (the lowest layer clusters c1, c2, c4, and c5) of the lowest layer cluster c3 in the neighbor list corresponding to the new lowest layer cluster c0. Each of the neighbor clusters of the lowest layer cluster c3 can be specified by obtaining a neighbor list of the lowest layer cluster c3 from the graph-based index information. The process of registering the identifier of each of the neighbor clusters (Lowest layer clusters c1, c2, c4, and c5) in the neighbor list corresponding to the new lowest layer cluster c0 may be executed in order from the neighbor cluster having a short distance as viewed from the new lowest layer cluster c0. The lowest layer cluster c2 is also the neighbor cluster of the lowest layer cluster c3, but in a case where a distance from the new lowest layer cluster c0 to the lowest layer cluster c2 exceeds a certain reference value or in a case where the total number of clusters registered in the neighbor list corresponding to the new lowest layer cluster c0 reaches a certain upper limit value, the identifier of the lowest layer cluster c2 does not need to be registered in the neighbor list corresponding to the new lowest layer cluster c0.

Then, the processor 11 registers the identifier of the new lowest layer cluster c0 in the neighbor list corresponding to the lowest layer cluster c3. As a result, the identifier of the lowest layer cluster c3 is registered in the neighbor list corresponding to the new lowest layer cluster c0, and the identifier of the new lowest layer cluster c0 is registered in the neighbor list corresponding to the lowest layer cluster c3. Thus, the new lowest layer cluster c0 and the lowest layer cluster c3 are connected by an edge e03.

Similarly, the processor 11 registers the identifier of the new lowest layer cluster c0 in each of the neighbor list corresponding to the lowest layer cluster c1, the neighbor list corresponding to the lowest layer cluster c4, and the neighbor list corresponding to the lowest layer cluster c5. As a result, the new lowest layer cluster c0 and the lowest layer cluster c1 are connected by an edge e01, the new lowest layer cluster c0 and the lowest layer cluster c4 are connected by an edge e04, and the new lowest layer cluster c0 and the lowest layer cluster c5 are connected by an edge e05.

The existing edge e35 between the lowest layer cluster c3 and the lowest layer cluster c5 may be deleted as necessary.

For example, in a case where the overflow in which the total number of clusters registered in the neighbor list of the lowest layer cluster c3 exceeds the upper limit value occurs due to the registration of the identifier of the new lowest layer cluster c0, the identifier of a cluster having the longest distance from the lowest layer cluster c3 may be deleted from the neighbor list of the lowest layer cluster c3. In a case where the cluster having the longest distance is a cluster isolated by deleting the identifier of this cluster (there is no neighbor cluster), the identifier of a cluster having the next longest distance is deleted.

The processor 11 registers the identifier of the new lowest layer cluster c0 in the lower layer cluster list of the higher layer cluster L2-c, for example.

Thereafter, the processor 11 specifies one or more vectors closer to the reference position of the new lowest layer cluster c0 than the reference position of the lowest layer cluster c3 from among all the vectors already belonging to the lowest layer cluster c3 and the new vector Va. Then, the processor 11 registers the identifier of each of the one or more specified vectors in the belonging vector list corresponding to the new lowest layer cluster c0. The processor 11 deletes the identifier of each vector registered in the belonging vector list of the lowest layer cluster c3 among the one or more specified vectors from the belonging vector list of the lowest layer cluster c3.

FIG. 8 illustrates, as an example, a case where the new vector Va is added to the new lowest layer cluster c0 and the vector v34 is moved from the lowest layer cluster c3 to the new lowest layer cluster c0.

A process similar to the process for the lowest layer cluster c3 is executed for all the neighbor clusters of the new lowest layer cluster c0. As a result, for example, in a case where the vector v41 is closer to the reference position of the new lowest layer cluster c0 than the reference position of the lowest layer cluster c4, the vector v41 is moved from the lowest layer cluster c4 to the new lowest layer cluster c0 as illustrated in FIG. 8.

During the execution of the cluster addition process, the new lowest layer cluster c0 may be determined as the search start cluster.

In this case, in the belonging vector list of the new lowest layer cluster c0, there is a case where no vector is registered yet, or only some vectors among vectors belonging to the new lowest layer cluster c0 are registered. In this case, it is difficult to correctly search for the approximate nearest neighbor vector of the query. Therefore, the processor 11 executes the following process.

When detecting that the new lowest layer cluster c0 is determined as the search start cluster during the execution of the cluster addition process, the processor 11 adds all the vectors registered in the belonging vector list of the lowest layer cluster c3 to the search target. The processor 11 searches for a vector closest to the query as the nearest neighbor vector in the search start cluster, from among all the vectors registered in the belonging vector list of the new lowest layer cluster c0 and all the vectors registered in the belonging vector list of the lowest layer cluster c3.

As a result, even in a case where the new lowest layer cluster c0 is determined as the search start cluster in a state where the movement of the vector from the lowest layer cluster c3 to the new lowest layer cluster c0 is not completed, the nearest neighbor vector in the search start cluster can be correctly searched for.

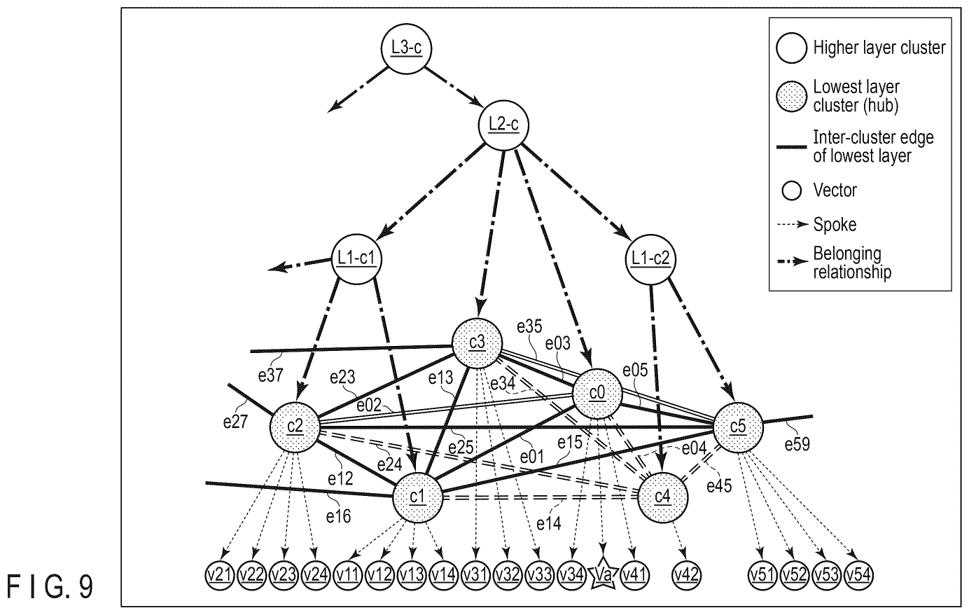

Next, a process of deleting a cluster (lowest layer cluster) from the inter-cluster graph CG will be described. FIG. 9 is a diagram illustrating an index update process for deleting a cluster whose number of belonging vectors is zero.

When deleting one vector from the data set 21 of the vector database, the processor 11 specifies a cluster (lowest layer cluster) to which this one vector belongs, and deletes this one vector from the belonging vector list of the specified cluster.

The deletion of one vector may cause the number of vectors belonging to the specified cluster to be zero.

For example, FIG. 9 illustrates an example in which the number of vectors registered in the belonging vector list of the lowest layer cluster c4 is zero by deletion of the vector v42 as a deletion target.

In this case, the processor 11 acquires the neighbor list of the lowest layer cluster c4 from the graph-based index information, and specifies one or more clusters (that is, one or more neighbor clusters of the lowest layer cluster c4) registered in the acquired neighbor list. In FIG. 9, the lowest layer clusters c0, c1, c2, c3, and c5 are specified as the neighbor clusters of the lowest layer cluster c4.

Then, the processor 11 executes, for each neighbor cluster of the lowest layer cluster c4, a process of deleting the identifier of the lowest layer cluster c4 from the neighbor list of the neighbor cluster. In this case, the identifier of the lowest layer cluster c4 is deleted from the neighbor list of the lowest layer cluster c0, and similarly, the identifier of the lowest layer cluster c4 is also deleted from the neighbor list of each of the lowest layer clusters c1, c2, c3, and c5. As a result, the edge e04 connecting the lowest layer cluster c0 and the lowest layer cluster c4, the edge e14 connecting the lowest layer cluster c1 and the lowest layer cluster c4, the edge e24 connecting the lowest layer cluster c2 and the lowest layer cluster c4, the edge e34 connecting the lowest layer cluster c3 and the lowest layer cluster c4, and the edge e45 connecting the lowest layer cluster c5 and the lowest layer cluster c4 are deleted.

Further, the processor 11 executes, for each of the neighbor clusters of the lowest layer cluster c4, a process of determining a cluster that is not registered in the neighbor list of the neighbor cluster and is registered in the neighbor list of the lowest layer cluster c4, and a process of registering an identifier of the determined cluster in the neighbor list of the neighbor cluster.

For example, regarding the lowest layer cluster c3, a cluster that is not registered in the neighbor list of the lowest layer cluster c3 and is registered in the neighbor list of the lowest layer cluster c4 is the lowest layer cluster c5.

Similarly, regarding the lowest layer cluster c5, a cluster that is not registered in the neighbor list of the lowest layer cluster c5 and is registered in the neighbor list of the lowest layer cluster c4 is the lowest layer cluster c3.

Therefore, a process of registering the identifier of the lowest layer cluster c5 in the neighbor list of the lowest layer cluster c3 and a process of registering the identifier of the lowest layer cluster c3 in the neighbor list of the lowest layer cluster c5 are executed. As a result, the lowest layer cluster c3 and the lowest layer cluster c5 are connected to each other by the edge e35.

For example, regarding the lowest layer cluster c2, a cluster that is not registered in the neighbor list of the lowest layer cluster c2 and is registered in the neighbor list of the lowest layer cluster c4 is the lowest layer cluster c0.

Similarly, regarding the lowest layer cluster c0, a cluster that is not registered in the neighbor list of the lowest layer cluster c0 and is registered in the neighbor list of the lowest layer cluster c4 is the lowest layer cluster c2.

Therefore, a process of registering the identifier of the lowest layer cluster c0 in the neighbor list of the lowest layer cluster c2 and a process of registering the identifier of the lowest layer cluster c2 in the neighbor list of the lowest layer cluster c0 are executed. As a result, the lowest layer cluster c2 and the lowest layer cluster c0 are connected to each other by the edge e02.

In a case where the overflow has occurred in the neighbor list of a certain lowest layer cluster among the lowest layer clusters c1, c2, c3, and c5, the identifier of the cluster having the longest distance from the lowest layer cluster among the clusters that are not isolated even though being deleted is deleted from the neighbor list of the lowest layer cluster.

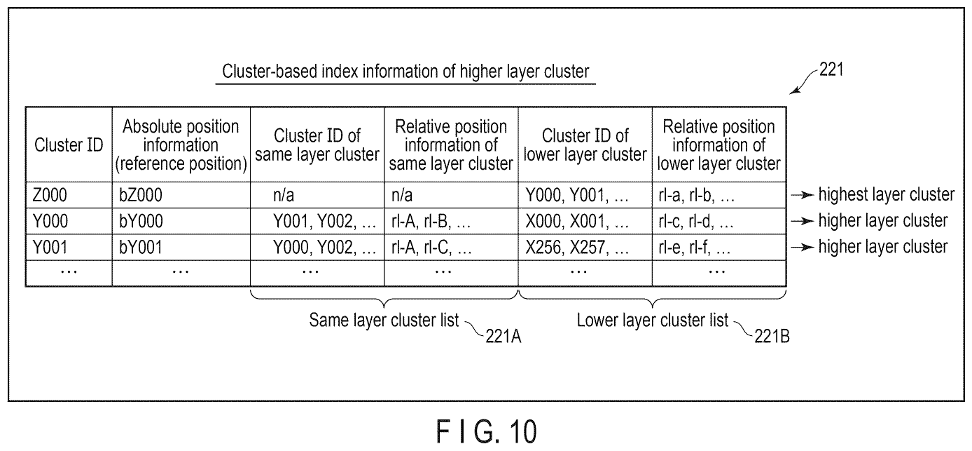

FIG. 10 is a diagram illustrating an example of higher layer cluster index information 221. The higher layer cluster index information 221 is cluster-based index information corresponding to each of the higher layer clusters.

The higher layer cluster index information 221 includes a plurality of entries respectively corresponding to a plurality of higher layer clusters. Each entry includes fields of, for example, a cluster ID, a reference position, a cluster ID of a lower layer cluster, relative position information (distance information and direction information) of the lower layer cluster, a cluster ID of the same layer cluster, and relative position information (distance information and direction information) of the same layer cluster.

In an entry corresponding to a certain higher layer cluster, the cluster ID field indicates an identifier (cluster ID) assigned to the higher layer cluster. The cluster ID is information for enabling the corresponding cluster to be uniquely identified.

The reference position field indicates a reference position (absolute position information) of the corresponding higher layer cluster. As the reference position of a certain higher layer cluster, the reference position of any one lower layer cluster among the lower layer clusters belonging to the higher layer cluster may be used.

The cluster ID field of the lower layer cluster indicates a list of one or more cluster IDs respectively assigned to one or more lower layer clusters belonging to the corresponding higher layer cluster. In the cluster ID field of the lower layer cluster, for example, one or more cluster IDs are listed. The lower layer cluster belonging to the higher layer cluster is also referred to as a belonging lower layer cluster.

The relative position information field of the lower layer cluster indicates a positional relationship between a reference position of the corresponding higher layer cluster and a reference position of each of the lower layer clusters belonging to the higher layer cluster. Specifically, the relative position information field of the lower layer cluster includes distance information indicating a distance between the reference position of the higher layer cluster and the reference position of each of the lower layer clusters. In the relative position information field of the lower layer cluster, for example, one or more pieces of distance information respectively corresponding to one or more belonging lower layer clusters are listed.

The relative position information field of the lower layer cluster may further include direction information indicating a direction from the reference position of the higher layer cluster to the reference position of each of the lower layer clusters.

The cluster ID field of the lower layer cluster and the relative position information field of the lower layer cluster are used as a lower layer cluster list 221B for retaining information regarding each lower layer cluster belonging to the higher layer cluster, for each higher layer cluster.

The cluster ID field of the same layer cluster indicates a list of one or more cluster IDs respectively assigned to one or more clusters (the same layer cluster) located in the same layer as the corresponding higher layer cluster. In the cluster ID field of the same layer cluster, for example, the one or more cluster IDs are listed.

The relative position information field of the same layer cluster indicates a positional relationship between the reference position of the corresponding higher layer cluster and the reference position of each of the same layer clusters located in the same layer as the higher layer cluster. Specifically, the relative position information field of the same layer cluster includes distance information indicating a distance between the reference position of the higher layer cluster and the reference position of each of the same layer clusters. In the relative position information field of the same layer cluster, for example, one or more pieces of distance information respectively corresponding to one or more same layer clusters are listed.

The relative position information field of the same layer cluster may further include direction information indicating a direction from the reference position of the higher layer cluster to the reference position of each of the same layer clusters.

The cluster ID field of the same layer cluster and the relative position information field of the same layer cluster are used as a same layer cluster list 221A for retaining information regarding each of the same layer clusters located in the same layer as the higher layer cluster, for each higher layer cluster.

With the above configuration, the search unit 113 can perform the approximate nearest neighbor cluster search by using the higher layer cluster index information 221.

In a case where the reference position of a certain lower layer cluster in a certain higher layer cluster is used as the reference position of the higher layer cluster, the “relative position information of the same layer cluster” corresponding to this lower layer cluster can be used as the “relative position information of the lower layer cluster” corresponding to this higher layer cluster.

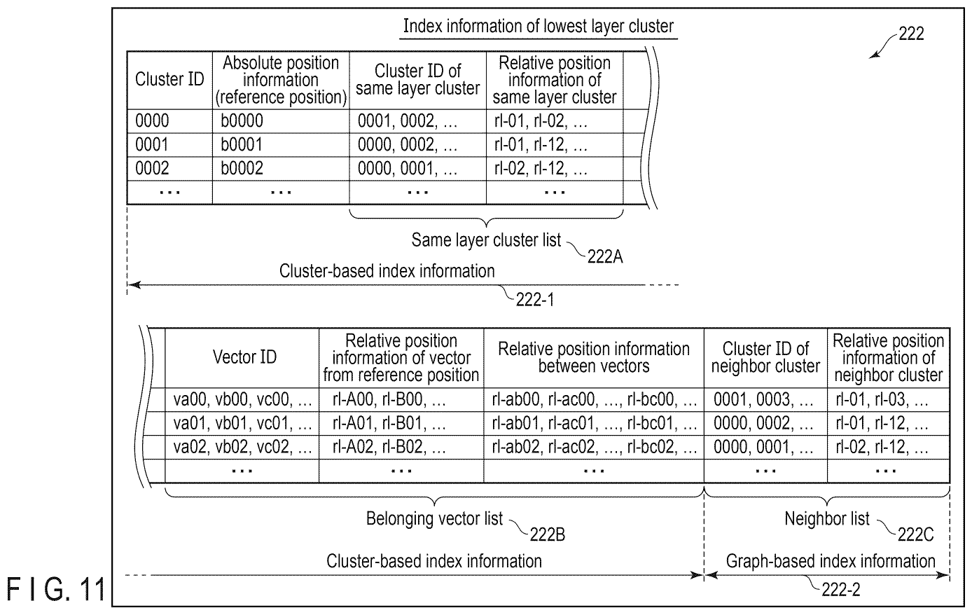

FIG. 11 is a diagram illustrating an example of lowest layer cluster index information 222. The lowest layer cluster index information 222 is cluster-based index information corresponding to each of the lowest layer clusters.

The lowest layer cluster index information 222 includes cluster-based index information 222-1 corresponding to each of the lowest layer clusters and graph-based index information 222-2 corresponding to each of the lowest layer clusters.

First, the cluster-based index information 222-1 corresponding to each of the lowest layer clusters will be described.

The cluster-based index information 222-1 includes a plurality of entries respectively corresponding to a plurality of lowest layer clusters. Each entry includes fields of, for example, a cluster ID, a reference position, a cluster ID of a same layer cluster, relative position information (distance information and direction information) of the same layer cluster, a vector ID, relative position information (distance information and direction information) of a vector from the reference position, and relative position information between vectors.

In an entry corresponding to a certain lowest layer cluster, the cluster ID field indicates an identifier (cluster ID) assigned to the lowest layer cluster. The cluster ID is information for enabling the corresponding cluster to be uniquely identified.

The reference position field indicates a reference position (absolute position information) of the corresponding lowest layer cluster. As a reference position of a certain lowest layer cluster, any one of the vectors belonging to the lowest layer cluster may be used.

The cluster ID field of the same layer cluster indicates a list of one or more cluster IDs respectively assigned to one or more clusters (the same layer cluster) located in the same layer as the corresponding lowest layer cluster. In the cluster ID field of the same layer cluster, for example, one or more cluster IDs are listed.

The relative position information field of the same layer cluster indicates a positional relationship between the reference position of the corresponding lowest layer cluster and the reference position of each of the same layer clusters located in the same layer as the lowest layer cluster. Specifically, the relative position information field of the same layer cluster includes distance information indicating a distance between the reference position of the lowest layer cluster and the reference position of each of the same layer clusters. In the relative position information field of the same layer cluster, for example, one or more pieces of distance information respectively corresponding to one or more same layer clusters are listed.

The relative position information field of the same layer cluster may further include direction information indicating a direction from the reference position of the lowest layer cluster to the reference position of each of the same layer clusters.

The cluster ID field of the same layer cluster and the relative position information field of the same layer cluster are used as a same layer cluster list 222A for retaining information regarding each of the same layer clusters located in the same layer as the lowest layer cluster, for each lowest layer cluster.

The vector ID field indicates a list of one or more vector IDs respectively assigned to one or more vectors belonging to the corresponding lowest layer cluster. In the vector ID field, for example, the one or more vector IDs are listed. The vector belonging to the lowest layer cluster is also referred to as a belonging vector.

The relative position information field of the vector from the reference position indicates a positional relationship between the reference position of the corresponding lowest layer cluster and each of the vectors belonging to the lowest layer cluster. Specifically, the relative position information field of the vector from the reference position includes distance information indicating a distance between the reference position of the lowest layer cluster and each of the belonging vectors. In the relative position information field of the vector from the reference position, for example, one or more pieces of distance information respectively corresponding to one or more belonging vectors are listed.

The relative position information field of the vector from the reference position may further include direction information indicating a direction from the reference position of the lowest layer cluster to each of the belonging vectors.

The relative position information field between vectors indicates a positional relationship between vectors belonging to the corresponding lowest layer cluster. Specifically, the relative position information field between vectors includes distance information indicating a distance from each of the belonging vectors to each of the other belonging vectors, for each of the belonging vectors.

The relative position information field between the vectors may further include direction information indicating a direction from the belonging vector to each of the other belonging vectors, for each belonging vector.

The vector ID field, the relative position information field of the vector from the reference position, and the relative position information field between vectors are used as a belonging vector list 222B for retaining information regarding each vector belonging to the lowest layer cluster, for each lowest layer cluster.

The graph-based index information 222-2 corresponding to each of the lowest layer clusters includes a plurality of entries respectively corresponding to a plurality of lowest layer clusters. Each entry includes, for example, fields of a neighbor cluster ID and relative position information of the neighbor cluster.

The neighbor cluster ID field indicates a list of one or more cluster IDs respectively assigned to other one or more lowest layer clusters (neighbor clusters) connected to the corresponding lowest layer cluster by an edge. In the neighbor cluster ID field, for example, the one or more cluster IDs are listed.

The relative position information field of the neighbor cluster indicates a positional relationship between the reference position of the corresponding lowest layer cluster and the reference position of each of the neighbor clusters of the lowest layer cluster. Specifically, the relative position information field of the neighbor cluster includes distance information indicating a distance between the reference position of the lowest layer cluster and the reference position of each of the neighbor clusters. In the relative position information field of the neighbor cluster, for example, one or more pieces of distance information respectively corresponding to one or more neighbor clusters are listed.

The relative position information field of the neighbor cluster may further include direction information indicating a direction from the reference position of the lowest layer cluster to the reference position of each of the neighbor clusters.

The cluster ID field of the neighbor cluster and the relative position information field of the neighbor cluster are used as an neighbor list 222C for retaining information indicating a relationship between the lowest layer cluster and each neighbor cluster corresponding to the lowest layer cluster, for each lowest layer cluster.

In a case where a certain belonging vector in a certain lowest layer cluster is used as a reference position (reference vector) of the lowest layer cluster, “relative position information between vectors” corresponding to the belonging vector can be used as “relative position information of a vector from the reference position” corresponding to the lowest layer cluster.

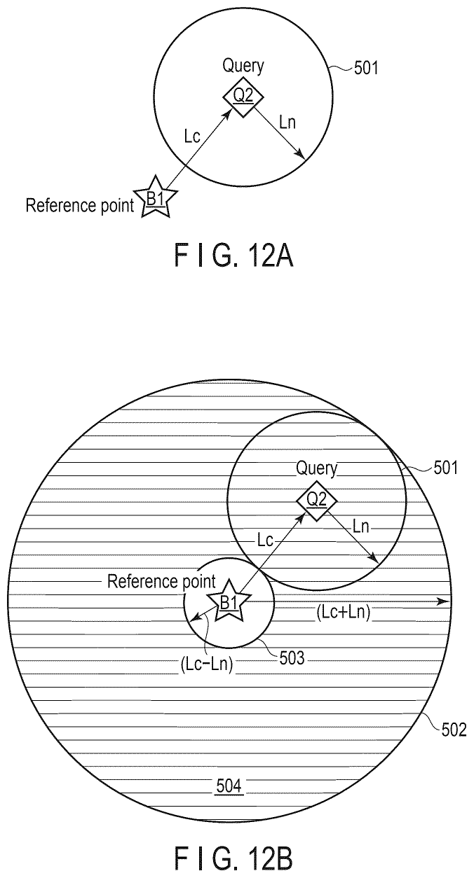

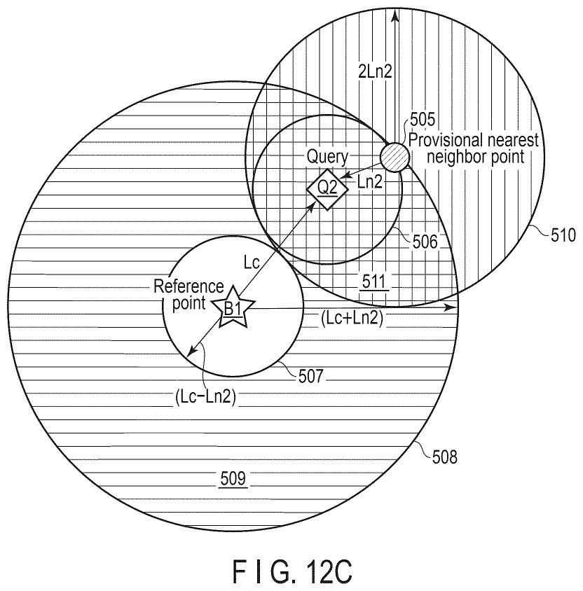

Next, a principle of the approximate nearest neighbor vector search using the distance between vectors will be described. FIGS. 12A to 12C are diagrams for describing examples of the principle of the approximate nearest neighbor vector search using the distance between vectors.

Here, it is assumed that in a case where a query Q2 which is based on a query from the external device 2 is received, and a provisional nearest neighbor point and a provisional nearest neighbor distance Ln are obtained by searching for any cluster (lowest layer cluster) based on the query Q2, the approximate nearest neighbor vector search is further performed with another cluster as the target cluster. The provisional nearest neighbor point is a nearest neighbor vector in any lowest layer cluster found by searching for a cluster (lowest layer cluster) based on the query Q2. The provisional nearest neighbor distance Ln is a distance between the provisional nearest neighbor point and the query Q2. A plurality of vectors belong to the target cluster. In FIG. 12A, a reference point B1 (reference vector B1) is a reference position of the target cluster. In the target cluster, the distance between the vectors is calculated in advance.

As illustrated in FIG. 12A, the search unit 113 calculates a distance Lc between the reference point B1 of the target cluster and the query Q2. The distance Lc is longer than the provisional nearest neighbor distance Ln. In this case, ideally, it is desirable to search for a vector within a range 501 of the radius Ln centered on the query Q2. However, the distance between the query Q2 and each vector is unknown until calculation. Therefore, in order to determine whether each vector is inside or outside the range 501, it is necessary to calculate the distance between the query Q2 and each vector, which increases the calculation amount.

Therefore, as illustrated in FIG. 12B, the search unit 113 determines a search range 504 obtained by excluding a range 503 having a radius of a distance (Lc−Ln) obtained by subtracting the provisional nearest neighbor distance Ln from the distance Lc centered on the reference point B1 from a range 502 having a radius of a distance (Lc+Ln) obtained by adding the provisional nearest neighbor distance Ln to the distance Lc centered on the reference point B1. The search range 504 is a range centered on the reference point B1, the range including all vectors whose distances from the query Q2 may be less than the provisional nearest neighbor distance Ln.

Then, as illustrated in FIG. 12C, the search unit 113 selects a vector 505 within the search range 504. The search unit 113 calculates a distance Ln2 between the vector 505 and the query Q2. The search unit 113 determines whether or not the distance Ln2 is less than the provisional nearest neighbor distance Ln. Here, since the distance Ln2 is less than the provisional nearest neighbor distance Ln, the search unit 113 sets the vector 505 as a new provisional nearest neighbor point. The search unit 113 sets the distance Ln2 as a new provisional nearest neighbor distance.

The search unit 113 determines a search range 509 obtained by excluding a range 507 having a radius of a distance (Lc−Ln2) obtained by subtracting the provisional nearest neighbor distance Ln2 from the distance Lc centered on the reference point B1 from a range 508 having a radius of a distance (Lc+Ln2) obtained by adding the provisional nearest neighbor distance Ln2 to the distance Lc centered on the reference point B1. The search range 509 is a range including all vectors whose distances from the query Q2 may be less than the provisional nearest neighbor distance Ln2. The search unit 113 can determine whether or not each vector is within the search range 509 based on the distance between the reference point B1 and each vector, which has been calculated in advance. As a result, the search unit 113 can exclude a vector outside the search range 509 from the search target.

The search unit 113 determines a search range 510 having a radius of 2Ln2 centered on the provisional nearest neighbor point 505. A vector within the search range 510 may be closer to the query Q2 than the provisional nearest neighbor point 505. The search unit 113 can determine whether or not each vector as the search target is within the search range 510 based on the distance between vectors, which has been calculated in advance. As a result, the search unit 113 can exclude a vector outside the search range 510 from the search target.

Further, the search unit 113 determines a search range 511 in which the search range 509 and the search range 510 overlap. A vector within the search range 511 may be closer to the query Q2 than the provisional nearest neighbor point 505. The search unit 113 may determine whether or not each vector as the search target is within the search range 511 based on the distance between the vectors, which has been calculated in advance, that is, based on the distance between the reference point B1 and each vector and the distance between the provisional nearest neighbor point 505 and each vector. As a result, the search unit 113 can exclude a vector outside the search range 511 from the search target.

In a case where a vector that has not been searched for and whose distance to the query Q2 is shorter than the provisional nearest neighbor distance Ln is within the search range 511, the search unit 113 executes a process of further narrowing the search range by using the vector as a new provisional nearest neighbor point, and searching for a vector within the search range. For example, the search unit 113 repeatedly executes this process until there is no unsearched vector in the search range.

In a case where there is no unsearched vector in the search range and in a case where the distance to the query Q2 is equal to or longer than the provisional nearest neighbor distance for any unsearched vector in the search range, the search unit 113 outputs the vector finally set as the provisional nearest neighbor point as the approximate nearest neighbor vector. For example, in a case where there is no unsearched vector in the search range 511 and in a case where the distance to the query Q2 is equal to or longer than the provisional nearest neighbor distance Ln2 for any unsearched vector in the search range 511, the search unit 113 outputs the vector 505 finally set as the provisional nearest neighbor point as the approximate nearest neighbor vector.

With the principle of the approximate nearest neighbor vector search described above, the search unit 113 can narrow the search range of the vector by using the distance between the vectors, which has been calculated in advance, and efficiently search for the approximate nearest neighbor vector.

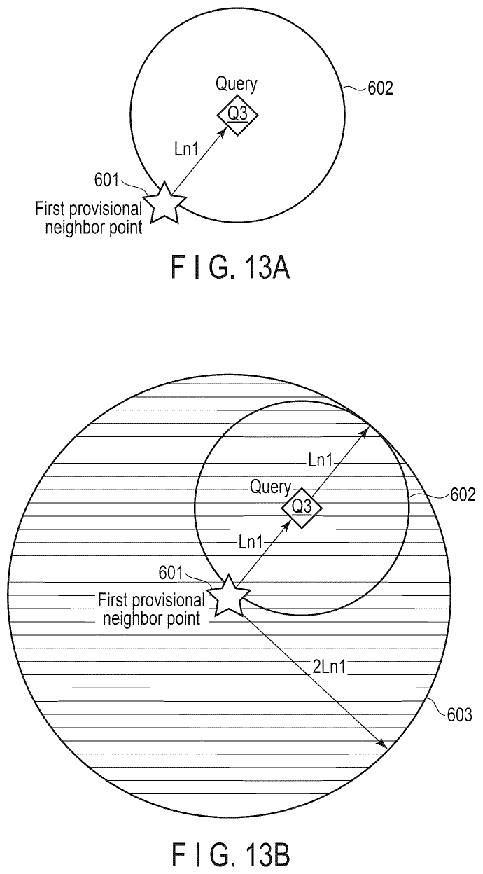

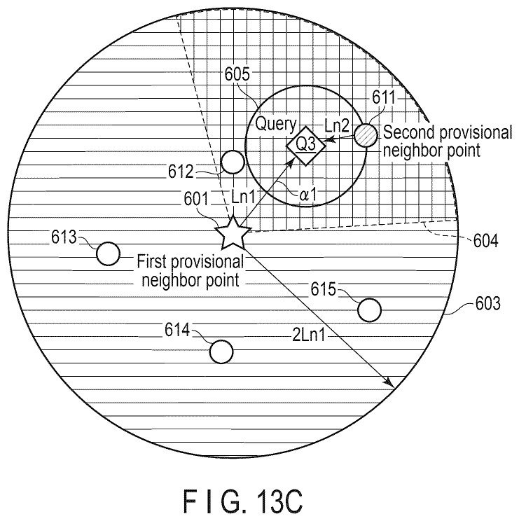

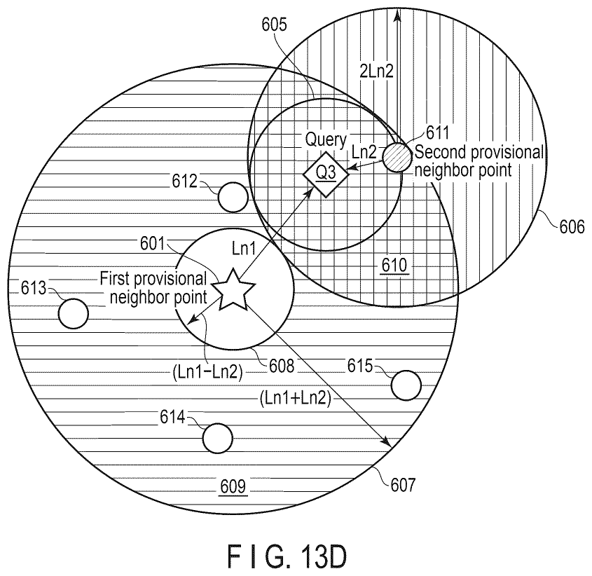

Next, examples of a principle of the approximate nearest neighbor vector search using the distance between vectors and the direction between vectors will be described. FIGS. 13A to 13D are diagrams for describing examples of the principle of approximate nearest neighbor vector search using the distance between vectors and the direction between vectors.

Here, it is assumed that a query Q3 which is based on a query from the external device 2 is received, and a first provisional nearest neighbor point 601 assumed to be close to the query Q3 is set. The first provisional nearest neighbor point 601 is, for example, any vector included in the data set 21 (vector database). This any vector may be, for example, a vector having a specific ID among a plurality of vectors included in the data set 21, or may be a vector randomly selected from the plurality of vectors. In a case where each of the plurality of vectors belongs to any one of a plurality of lowest layer clusters CL of the hierarchical cluster HC, and an approximate nearest neighbor cluster for the query Q3 among the plurality of lowest layer clusters CL is determined, the reference vector of the approximate nearest neighbor cluster may be used as the first provisional nearest neighbor point 601.

As illustrated in FIG. 13A, the search unit 113 calculates a distance Ln1 between the first provisional nearest neighbor point 601 and the query Q3. The distance between the vectors, which has been calculated by the search unit 113, is, for example, a Euclidean distance. In this case, ideally, it is desirable to search for a vector within a range 602 of the radius Ln1 centered on the query Q3. In other words, it is desirable to exclude a vector outside the range 602 from the search target. However, the distance between the query Q3 and each vector is unknown until calculation. Therefore, in order to determine whether each vector is inside or outside the range 602, it is necessary to calculate the distance between the query Q3 and each vector, which increases the calculation amount.

Therefore, as illustrated in FIG. 13B, the search unit 113 determines a search range 603 with a radius of 2Ln1 centered on the first provisional nearest neighbor point 601. A vector within the search range 603 may be closer to the query Q3 than the first provisional nearest neighbor point 601.

The distance between the vectors is calculated in advance (that is, this is calculated before the query Q3 is received). Specifically, for example, a distance between the first provisional nearest neighbor point 601 and each of a plurality of vectors as search targets is calculated in advance.

The search unit 113 can determine whether or not each vector as the search target is within the search range 603 based on the distance between vectors, which has been calculated in advance. As a result, the search unit 113 can exclude a vector outside the search range 603 from the search target.

In the example illustrated in FIG. 13C, five vectors 611 to 615 are included within the search range 603. The search unit 113 may determine that each of the five vectors 611 to 615 is within the search range 603 based on the distance between the vectors, which has been calculated in advance.

The search unit 113 calculates direction information α1 representing a direction from the first provisional nearest neighbor point 601 to the query Q3. The search unit 113 searches a specific direction range 604 centered on the direction information α1 within the search range 603 in order from being closest to the direction information α1.

The direction information between the vectors is calculated in advance. Specifically, for example, the direction information representing a direction from the first provisional nearest neighbor point 601 to each of the vectors 611 to 615 is calculated in advance.

Based on the distance between the vectors and the direction information between the vectors, which have been calculated in advance, the search unit 113 acquires a vector 611 that is within the search range 603 and in which the direction information from the first provisional nearest neighbor point 601 is more similar to the direction information α1. Specifically, the search unit 113 acquires, for example, the vector 611 that is within the search range 603 and corresponds to direction information in which a Hamming distance from the direction information α1 is equal to or less than a threshold value.

The search unit 113 calculates a distance Ln2 between the acquired vector 611 and the query Q3. The search unit 113 determines whether or not the distance Ln2 is less than the provisional nearest neighbor distance Ln1. Here, since the distance Ln2 is less than the distance Ln1, the search unit 113 sets the vector 611 as a second provisional nearest neighbor point 611.

In this case, ideally, it is desirable to search for a vector within a range 605 of the radius Ln2 centered on the query Q3. In other words, it is desirable to exclude a vector outside the range 605 from the search target. However, as described above, the distance between the query Q3 and each vector (for example, each of the vectors 612 to 615) is unknown until calculation.

Therefore, as illustrated in FIG. 13D, the search unit 113 determines a search range 606 with a radius of 2Ln2 centered on the second provisional nearest neighbor point 611. A vector within the search range 606 may be closer to the query Q3 than the second provisional nearest neighbor point 611. The search unit 113 can determine whether or not each vector as the search target is within the search range 606 based on the distance between vectors, which has been calculated in advance. As a result, the search unit 113 can exclude a vector outside the search range 606 from the search target.

The search unit 113 determines a search range 609 obtained by excluding a range 608 having a radius of a distance (Ln1−Ln2) obtained by subtracting the distance Ln2 from the distance Ln1 centered on the first provisional nearest neighbor point 601 from a range 607 having a radius of a distance (Ln1+Ln2) obtained by adding the distance Ln2 to the distance Ln1 centered on the first provisional nearest neighbor point 601. A vector within the search range 609 may be closer to the query Q3 than the second provisional nearest neighbor point 611. The search unit 113 can determine whether or not each vector as the search target is within the search range 609 based on the distance between vectors, which has been calculated in advance. As a result, the search unit 113 can exclude a vector outside the search range 609 from the search target.

Further, the search unit 113 determines a search range 610 in which the search range 606 and the search range 609 overlap. A vector within the search range 610 may be closer to the query Q3 than the second provisional nearest neighbor point 611. The search unit 113 may determine whether or not each vector as the search target is within the search range 610 based on the distance between the vectors, which has been calculated in advance, that is, based on the distance between the first provisional nearest neighbor point 601 and each vector and the distance between the second provisional nearest neighbor point 611 and each vector. As a result, the search unit 113 can exclude a vector outside the search range 610 from the search target.

In a case where a vector that has not been searched for and whose distance to the query Q3 is shorter than the distance Ln2 is within the search range 610, the search unit 113 executes a process of further narrowing the search range by using the vector as a new provisional nearest neighbor point, and searching for a vector within the search range. For example, the search unit 113 repeatedly executes this process until there is no unsearched vector in the search range. The unsearched vector is a vector whose distance to the query Q3 has not yet been calculated (evaluated).

In a case where there is no unsearched vector within the search range, the search unit 113 outputs a vector last set as the provisional nearest neighbor point, as the approximate nearest neighbor vector. For example, in a case where there is no unsearched vector within the search range 610, the search unit 113 outputs a vector set as the second provisional nearest neighbor point 611, as the approximate nearest neighbor vector.

With the principle of the approximate nearest neighbor vector search described above, the search unit 113 can narrow the search range of the vector by using the distance between the vectors and the direction between the vectors, which have been calculated in advance, and efficiently search for the approximate nearest neighbor vector.

The process of searching for the lower layer cluster closest to the query among a plurality of lower layer clusters belonging to a certain higher layer cluster can also be executed by a procedure similar to the principle of the approximate nearest neighbor vector search using the distance (or both the distance and the direction).

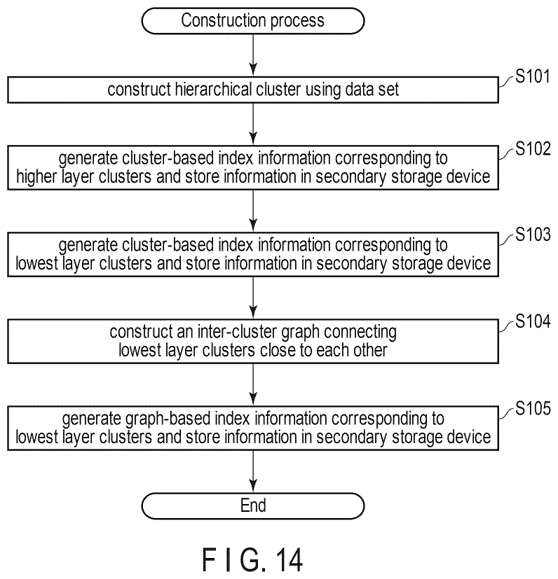

Next, a process executed in the approximate nearest neighbor search system 1 will be described with reference to FIGS. 14 to 20.

FIG. 14 is a flowchart illustrating an example of a procedure of a construction process of constructing the hybrid index structure including the hierarchical cluster and the inter-cluster graph. Specifically, the construction process is a process of generating the hybrid index information 22 including the hierarchical cluster HC and the inter-cluster graph CG by using the data set 21. For example, the processor 11 executes the construction process in response to the data set 21 being stored in the secondary storage device 14.

First, the processor 11 constructs a hierarchical cluster HC by using the data set 21 (Step S101). Specifically, the processor 11 determines the lowest layer cluster to which each of a plurality of vectors included in the data set 21 belongs such that one or more closer vectors belong to the same lowest layer cluster. The processor 11 determines the hierarchical structure HC of clusters such that one or more clusters whose reference positions are closer belong to the same higher layer cluster.

The processor 11 generates cluster-based index information 221 corresponding to a plurality of higher layer clusters based on the constructed hierarchical cluster HC, and stores the cluster-based index information 221 in the secondary storage device 14 (Step S102). The processor 11 generates cluster-based index information 222-1 corresponding to a plurality of lowest layer clusters based on the constructed hierarchical cluster HC, and stores the cluster-based index information 221-1 in the secondary storage device 14 (Step S103).

Then, the processor 11 constructs an inter-cluster graph CG joining close lowest layer clusters in the plurality of lowest layer clusters (Step S104). The processor 11 generates graph-based index information 222-2 corresponding to a plurality of lowest layer clusters based on the constructed inter-cluster graph CG, and stores the graph-based index information 222-2 in the secondary storage device 14 (Step S105). The processor 11 ends the construction process.

Through the above construction process, the processor 11 can construct the hybrid index structure 22 including the hierarchical cluster HC and the inter-cluster graph CG by using the data set 21. The processor 11 can generate the index information 221 corresponding to the higher layer cluster and the index information 222 corresponding to the lowest layer cluster based on the constructed hybrid index structure 22.

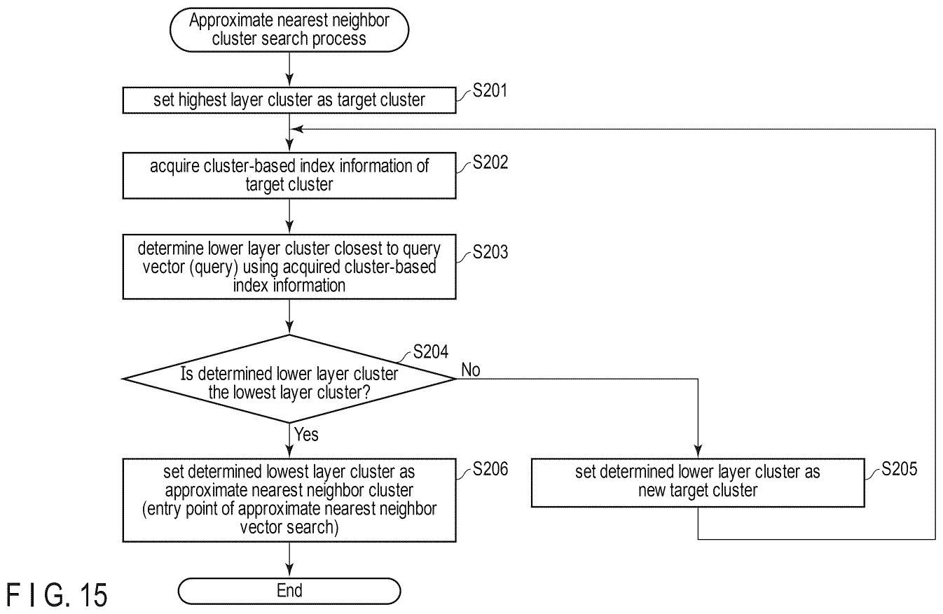

FIG. 15 is a flowchart illustrating an example of a procedure of the approximate nearest neighbor cluster (search start cluster) search process. The approximate nearest neighbor cluster search process is a process of determining an approximate nearest neighbor cluster (search start cluster) serving as an entry point of the approximate nearest neighbor vector search process. For example, the processor 11 executes the approximate nearest neighbor vector search process in response to reception of a query vector (query) based on a query from the external device 2. Here, a case where the search target for determining the approximate nearest neighbor cluster is the hierarchical cluster HC will be exemplified.

First, the processor 11 sets the highest layer cluster of the hierarchical cluster HC as the target cluster (Step S201). The processor 11 acquires the cluster-based index information 221 of the target cluster (Step S202). The cluster-based index information 221 as the target cluster is read from the secondary storage device 14 to the main memory 12, for example.

The processor 11 determines a lower layer cluster closest to the query among one or more lower layer clusters belonging to the target cluster by using the acquired cluster-based index information 221 (Step S203). Specifically, for example, the processor 11 calculates a distance between the reference position of the target cluster and the query. The processor 11 determines the lower layer cluster closest to the query by using the calculated distance and the relative position of each lower layer cluster to the target cluster.

Then, the processor 11 determines whether or not the determined lower layer cluster is the lowest layer cluster (Step S204).

In a case where the determined lower layer cluster is not the lowest layer cluster (No in Step S204), the processor 11 sets the lower layer cluster as a new target cluster (Step S205), and returns to Step S202. That is, a process of determining the lower layer cluster closest to the query among one or more lower layer clusters belonging to the new target cluster is executed.

In a case where the determined lower layer cluster is the lowest layer cluster (Yes in Step S204), the processor 11 sets the lowest layer cluster as an approximate nearest neighbor cluster (Step S206), and ends the approximate nearest neighbor cluster search process.

Through the above approximate nearest neighbor cluster search process, the processor 11 can determine the approximate nearest neighbor cluster of the query in the hierarchical cluster HC. The approximate nearest neighbor cluster is used as an entry point of the approximate nearest neighbor vector search process. The search target for determining the approximate nearest neighbor cluster may be a plurality of clusters (for example, the lowest layer cluster having a graph structure) having a graph structure instead of the hierarchical cluster HC.

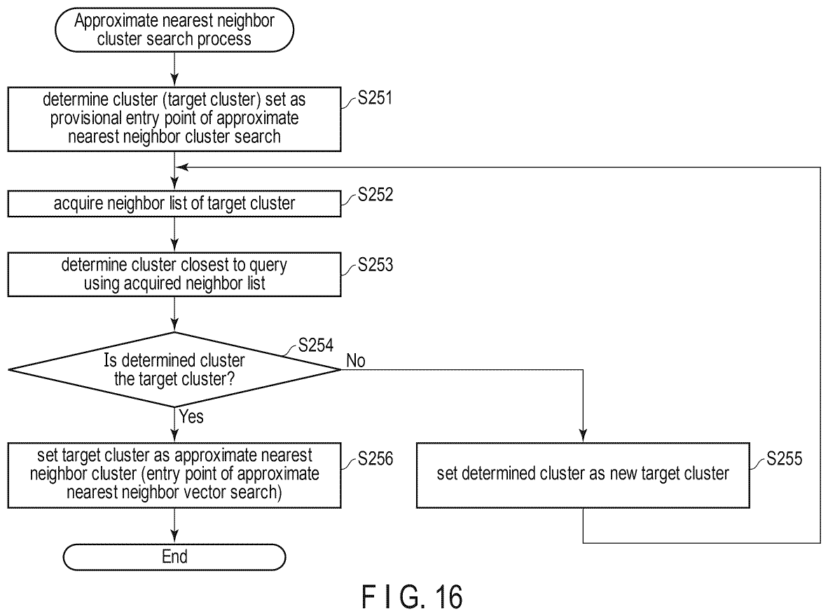

FIG. 16 is a flowchart illustrating an example of another procedure of the approximate nearest neighbor cluster (search start cluster) search process. Here, a case where the search target for determining the approximate nearest neighbor cluster is a plurality of clusters having the graph structure will be exemplified. The plurality of clusters having the graph structure correspond to the plurality of lowest layer clusters in the hierarchical cluster HC. That is, the plurality of clusters having the graph structure have a structure in which all the higher layer clusters are removed from the hierarchical cluster HC.

First, the processor 11 determines a cluster (target cluster) set as a provisional entry point of the approximate nearest neighbor cluster search (Step S251). The cluster set as the provisional entry point is any cluster, and may be, for example, a fixed specific cluster or a randomly selected cluster. The processor 11 acquires an neighbor list 222C (that is, the graph-based index information 222-2) of the target cluster (Step S252). The neighbor list 222C of the target cluster is read from the secondary storage device 14 to the main memory 12, for example. The neighbor list 222C includes, for example, information indicating one or more clusters (neighbor clusters) neighbor to the target cluster and the relative position of each of the one or more neighbor clusters with respect to the target cluster.

The processor 11 determines a cluster closest to the query among the target cluster and one or more neighbor clusters by using the acquired neighbor list 222C (Step S253). Specifically, the processor 11 calculates a distance between the reference position of the target cluster and the query. The processor 11 determines the cluster closest to the query by using the calculated distance and the relative position of each neighbor cluster with respect to the target cluster, for example.

The processor 11 determines whether or not the determined cluster closest to the query is the target cluster (Step S254). That is, the processor 11 determines whether the determined cluster closest to the query is the target cluster or an neighbor cluster of the target cluster.

In a case where the determined cluster is not the target cluster (No in Step S254), the processor 11 sets the determined cluster as a new target cluster (Step S255), and returns to Step S252. That is, a process of determining a cluster closest to the query from the new target cluster and one or more neighbor clusters of the new target cluster is executed.

In a case where the determined cluster is the target cluster (Yes in Step S254), the processor 11 sets the target cluster as an approximate nearest neighbor cluster (Step S256), and ends the approximate nearest neighbor cluster search process.

Through the above approximate nearest neighbor cluster search process, the processor 11 can determine the approximate nearest neighbor cluster of the query in a plurality of clusters having a graph structure.

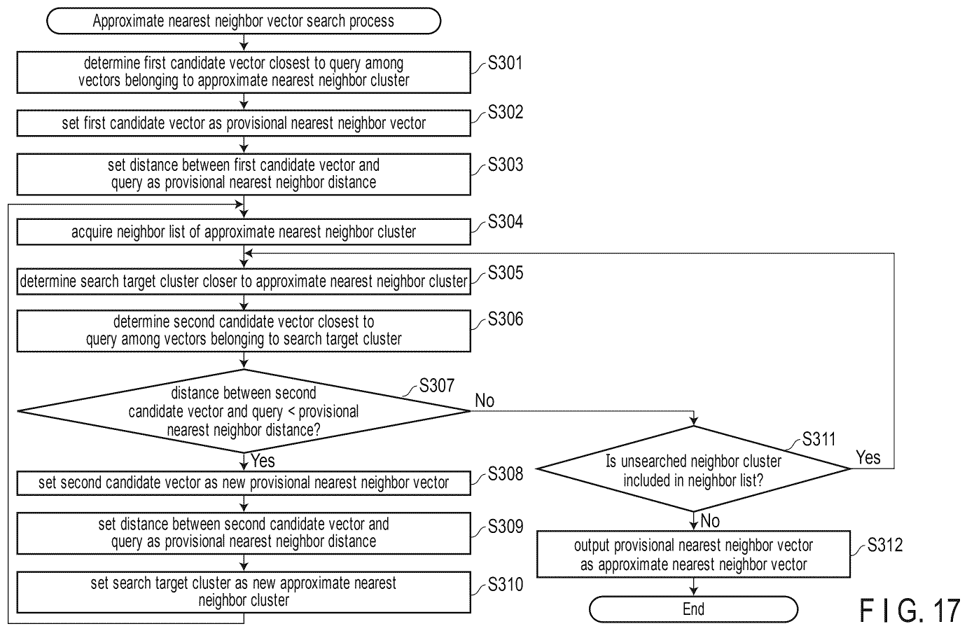

FIG. 17 is a flowchart illustrating an example of a procedure of the approximate nearest neighbor vector search process executed by the processor 11. The approximate nearest neighbor vector search process is a process of determining an approximate nearest neighbor vector of a query. For example, the processor 11 executes the approximate nearest neighbor vector search process in response to the determination of the approximate nearest neighbor cluster. Here, for example, it is assumed that the approximate nearest neighbor cluster is determined by the approximate nearest neighbor cluster search process described above with reference to FIG. 15 or FIG. 16. In this case, the processor 11 executes the approximate nearest neighbor vector search process with the approximate nearest neighbor cluster as an entry point.

First, the processor 11 determines a vector (first candidate vector) closest to the query among vectors belonging to the approximate nearest neighbor cluster (Step S301). The processor 11 sets the first candidate vector as a provisional nearest neighbor vector (Step S302). The processor 11 sets a distance between the first candidate vector and the query as the provisional nearest neighbor distance (Step S303).

Then, the processor 11 acquires the neighbor list 222C of the approximate nearest neighbor cluster (Step S304). The processor 11 determines an unsearched neighbor cluster (search target cluster) closer to the approximate nearest neighbor cluster by using the acquired neighbor list 222C (Step S305). Specifically, the processor 11 determines an unsearched neighbor cluster closer to the approximate nearest neighbor cluster among one or more neighbor clusters shown in the neighbor list 222C as the search target cluster. The neighbor cluster closer to the approximate nearest neighbor cluster is a neighbor cluster having at least one of the distance and direction information which is closer to the approximate nearest neighbor cluster.

The processor 11 determines a vector (second candidate vector) closest to the query among vectors belonging to the search target cluster (Step S306). The processor 11 determines whether or not a distance between the second candidate vector and the query is shorter than the provisional nearest neighbor distance (Step S307).

In a case where the distance between the second candidate vector and the query is shorter than the provisional nearest neighbor distance (Yes in Step S307), the processor 11 sets the second candidate vector as a new provisional nearest neighbor vector (Step S308). The processor 11 sets the distance between the second candidate vector and the query as a new provisional nearest neighbor distance (Step S309). The processor 11 sets the search target cluster as a new approximate nearest neighbor cluster (Step S310), and returns to Step S304. That is, a process of searching for an approximate nearest neighbor vector is executed by using the neighbor list 222C of the new approximate nearest neighbor cluster.

In a case where the distance between the second candidate vector and the query is equal to or larger than the provisional nearest neighbor distance (No in Step S307), the processor 11 determines whether or not an unsearched neighbor cluster is included in the neighbor list 222C of the approximate nearest neighbor cluster (Step S311).

In a case where the unsearched neighbor cluster is included in the neighbor list 222C of the approximate nearest neighbor cluster (Yes in Step S311), the processor 11 returns to Step S305. That is, a process of setting an unsearched neighbor cluster closer to the approximate nearest neighbor cluster as a new search target cluster and searching for an approximate nearest neighbor vector is executed.

In a case where the neighbor list 222C of the approximate nearest neighbor cluster does not include any unsearched neighbor cluster (No in Step S311), that is, in a case where the process of searching for the approximate nearest neighbor vector has been executed for all the neighbor clusters shown in the neighbor list 222C, the processor 11 outputs the provisional nearest neighbor vector as the approximate nearest neighbor vector (Step S312), and ends the approximate nearest neighbor vector search process.

Through the above-described approximate nearest neighbor vector search process, the processor 11 can determine the approximate nearest neighbor vector of the query by using, as an entry point, the approximate nearest neighbor cluster determined in the approximate nearest neighbor cluster search process.

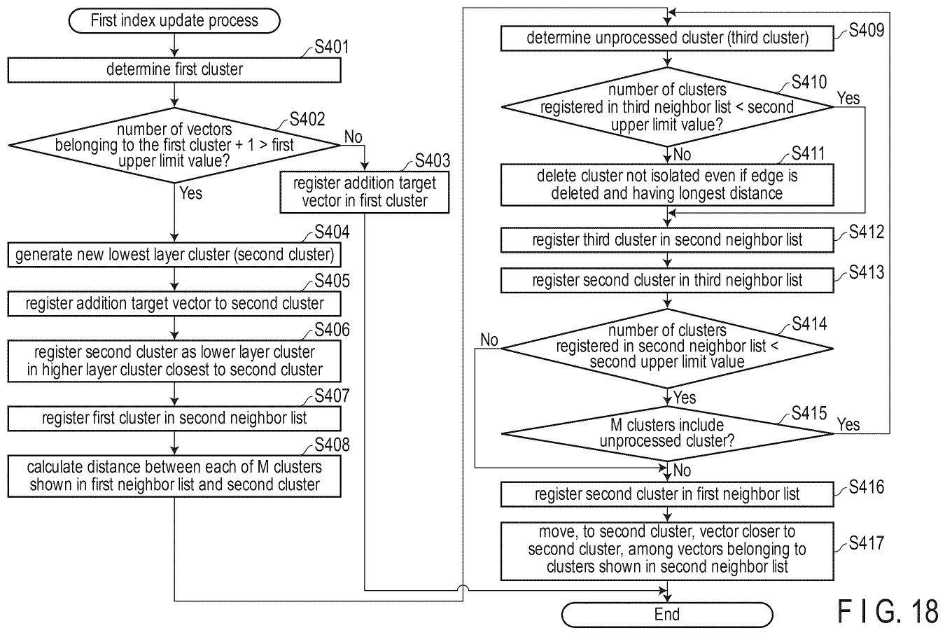

FIG. 18 is a flowchart illustrating an example of a procedure of a first index update process executed based on a vector added to the data set 21 of the vector database. The first index update process is a process of updating the hybrid index information 22 based on the vector added to the data set 21. For example, the processor 11 executes the first index update process in response to addition of the vector to the data set 21. The added vector is referred to as an addition target vector.

First, the processor 11 determines the lowest layer cluster (first cluster) closest to the addition target vector (Step S401). The first cluster is, for example, a lowest layer cluster of which the reference position is closest to the addition target vector among all the lowest layer clusters.

The processor 11 determines whether or not a value obtained by adding 1 to the number of vectors belonging to the first cluster exceeds a first upper limit value (Step S402). That is, when the addition target vector is newly registered in the first cluster, the processor 11 determines whether or not the number of vectors belonging to the first cluster exceeds the first upper limit value (that is, whether or not overflow occurs). The first upper limit value is an upper limit of the number of vectors that can belong to one lowest layer cluster.

In a case where the value obtained by adding 1 to the number of vectors belonging to the first cluster is equal to or less than the first upper limit value (No in Step S402), the processor 11 registers the addition target vector in the first cluster (Step S403), and ends the first index update process. Specifically, the processor 11 registers information (for example, the vector ID and the relative position information with respect to the reference position of the first cluster) corresponding to the addition target vector in a belonging vector list 222B of the first cluster.

In a case where the value obtained by adding 1 to the number of vectors belonging to the first cluster exceeds the first upper limit value (Yes in Step S402), the processor 11 generates a new lowest layer cluster (second cluster) (Step S404). Specifically, the processor 11 registers an entry of the second cluster in the index information 222 of the lowest layer cluster. The entry of the second cluster includes, for example, a cluster ID and a reference position (absolute position information) of the second cluster.

The processor 11 registers the addition target vector to the second cluster (Step S405). The processor 11 registers the second cluster as a lower layer cluster in a higher layer cluster closest to the second cluster (Step S406). Specifically, the processor 11 registers information (for example, the cluster ID and the relative position information with respect to the reference position of the higher layer cluster) corresponding to the second cluster in the lower layer cluster list 221B of the higher layer cluster.

The processor 11 registers the first cluster in the neighbor list 222C (second neighbor list 222C) of the second cluster (Step S407). Specifically, the processor 11 registers information (for example, the cluster ID and the relative position information with respect to the reference position of the second cluster) corresponding to the first cluster in the second neighbor list 222C.

The processor 11 calculates a distance between each of M clusters shown in the neighbor list 222C of the first cluster (the first neighbor list 222C) and the second cluster (Step S408). That is, the processor 11 calculates a distance between the reference position of each of the M clusters and the reference position of the second cluster. M is an integer of 1 or more. The processor 11 determines an unprocessed cluster (third cluster) closer to the second cluster among the M clusters (Step S409). The processor 11 determines whether or not the number of clusters registered in the neighbor list 222C (third neighbor list 222C) of the third cluster is less than a second upper limit value (Step S410). The second upper limit value is an upper limit of the number of neighbor clusters that can be registered in one lowest layer cluster.

In a case where the number of clusters registered in the third neighbor list 222C is less than the second upper limit value (Yes in Step S410), the processor 11 proceeds to Step S412.

In a case where the number of clusters registered in the third neighbor list 222C is equal to or larger than the second upper limit value (No in Step S410), the processor 11 deletes, from the third neighbor list 222C, a cluster that is not isolated even if the edge (that is, the inter-cluster edge) to the third cluster is deleted and has the longest distance (Step S411), and proceeds to Step S412.

Then, the processor 11 registers the third cluster in the second neighbor list 222C (Step S412). The processor 11 registers the second cluster in the third neighbor list 222C (Step S413). The processor 11 determines whether or not the number of clusters registered in the second neighbor list 222C is less than the second upper limit value (Step S414).

In a case where the number of clusters registered in the second neighbor list 222C is less than the second upper limit value (Yes in Step S414), the processor 11 determines whether or not M clusters include an unprocessed cluster (Step S415). In a case where M clusters include an unprocessed cluster (Yes in Step S415), the processor 11 returns to Step S409. That is, a process of registering the unprocessed cluster and the second cluster in the neighbor list 222C is executed.

In a case where the number of clusters registered in the second neighbor list 222C is equal to or larger than the second upper limit value (No in Step S414) and in a case where the M clusters do not include any unprocessed cluster (No in Step S415), the processor 11 registers the second cluster in the first neighbor list 222C (Step S416). The processor 11 moves, to the second cluster, a vector closer to the second cluster than the neighbor cluster to which this vector belongs, among the vectors belonging to each of the one or more neighbor clusters shown in the second neighbor list 222C (Step S417), and ends the first index update process. Specifically, the processor 11 deletes information corresponding to the moved vector from the belonging vector list 222B of the neighbor cluster to which the vector belongs, and registers the information in the belonging vector list 222B of the second cluster.

Through the above-described first index update process, the processor 11 can update the hybrid index information 22 based on the addition target vector.

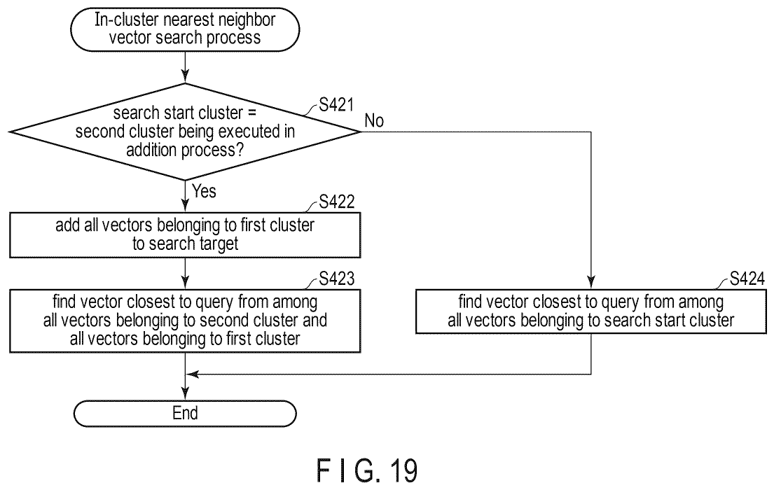

FIG. 19 is a flowchart illustrating an example of a procedure of an in-cluster nearest neighbor vector search process executed in a case where a cluster on which an addition process is being executed is determined as the search start cluster. The in-cluster nearest neighbor vector search process is a process of searching for a vector closest to the query from the cluster determined as the search start cluster.

The processor 11 determines whether or not the search start cluster determined based on the query is a cluster (second cluster) on which the addition process (cluster addition process) is being executed (Step S421). The second cluster corresponds to a lowest layer cluster newly generated at a position close to a certain lowest layer cluster (first cluster).

In a case where the search start cluster is a cluster (second cluster) on which the cluster addition process is being executed (Yes in Step S421), the processor 11 adds all the vectors belonging to the first cluster to the search target (Step S422).

The processor 11 finds a vector closest to the query from among all the vectors belonging to the second cluster and all the vectors belonging to the first cluster (Step S423).

On the other hand, in a case where the search start cluster is not a cluster on which the cluster addition process is being executed (No in Step S421), the processor 11 finds a vector closest to the query from among all the vectors belonging to the search start cluster (Step S424).

Through the above process, even in a case where the second cluster is determined as the search start cluster in a state where the movement of the vector from the first cluster to the second cluster is not completed, the vector closest to the query can be correctly found.

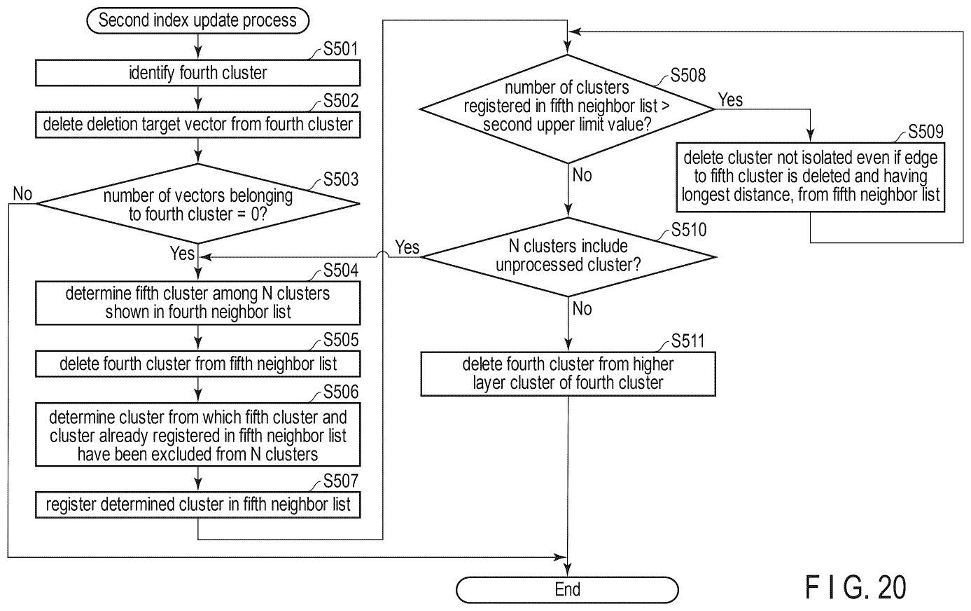

FIG. 20 is a flowchart illustrating an example of a procedure of a second index update process executed when a vector is deleted from the data set 21 of the vector database. The second index update process is a process of updating the hybrid index information 22 based on the vector deleted from the data set 21. For example, the processor 11 executes the second index update process in response to a request to delete a vector from the data set 21. The vector requested to be deleted is referred to as a deletion target vector.

First, the processor 11 specifies a lowest layer cluster (fourth cluster) to which the deletion target vector belongs (Step S501). The processor 11 deletes the deletion target vector from the fourth cluster (Step S502). Specifically, the processor 11 deletes information (for example, the vector ID and the relative position information with respect to the reference position of the fourth cluster) corresponding to the deletion target vector from the belonging vector list 222B of the fourth cluster. The processor 11 determines whether or not the number of vectors belonging to the fourth cluster becomes 0 (Step S503).

In a case where the number of vectors belonging to the fourth cluster is 1 or more (No in Step S503), the processor 11 ends the second index update process.

In a case where the number of vectors belonging to the fourth cluster becomes 0 (Yes in Step S503), the processor 11 determines an unprocessed cluster (fifth cluster) among N clusters shown in the neighbor list 222C (fourth neighbor list 222C) of the fourth cluster (Step S504). N is an integer of 1 or more. The processor 11 deletes the fourth cluster from the neighbor list 222C (fifth neighbor list 222C) of the fifth cluster (Step S505). The processor 11 determines a cluster from which the fifth cluster and the cluster already registered in the fifth neighbor list 222C have been excluded from the N clusters (Step S506). The processor 11 registers the determined cluster in the fifth neighbor list 222C (Step S507). The processor 11 determines whether or not the number of clusters registered in the fifth neighbor list 222C exceeds the second upper limit value (Step S508).

In a case where the number of clusters registered in the fifth neighbor list 222C exceeds the second upper limit value (Yes in Step S508), the processor 11 deletes, from the fifth neighbor list 222C, a cluster that is not isolated even if the edge to the fifth cluster is deleted and has the longest distance (Step S509), and proceeds to Step S508. That is, it is determined whether or not the number of clusters registered in the fifth neighbor list 222C is equal to or less than the second upper limit value by the deletion of the cluster in Step S509.

In a case where the number of clusters registered in the fifth neighbor list 222C is equal to or less than the second upper limit value (No in Step S508), the processor 11 determines whether or not N clusters include an unprocessed cluster (Step S510).

In a case where the N clusters include an unprocessed cluster (Yes in Step S510), the processor 11 returns to Step S504. That is, a process of deleting the fourth cluster from the neighbor list 222C of unprocessed clusters and registering a cluster, which is not registered in the neighbor list 222C of unprocessed clusters among the clusters shown in the neighbor list 222C of the fourth cluster, in the neighbor list 222C of the unprocessed clusters is executed.

In a case where an unprocessed cluster is not included in the N clusters (No in Step S510), the processor 11 deletes the fourth cluster registered as the lower layer cluster from the higher layer cluster of the fourth cluster (Step S511), and ends the second index update process. Specifically, the processor 11 deletes information (for example, the cluster ID and the relative position information with respect to the reference position of the higher layer cluster) corresponding to the fourth cluster, from the lower layer cluster list 221B of the higher layer cluster.

Through the above-described second index update process, the processor 11 can update the hybrid index information 22 based on the deletion target vector.

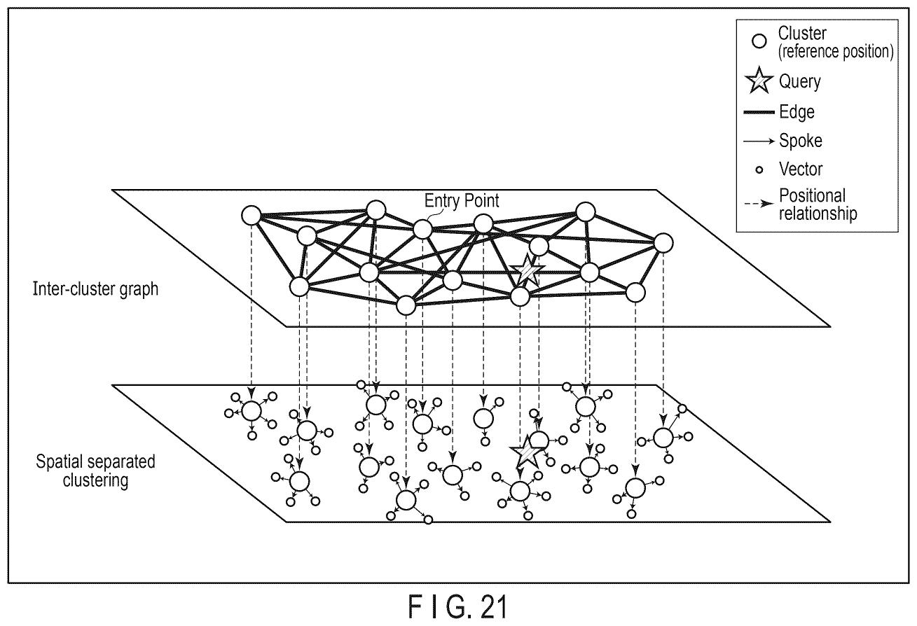

Next, some modification examples related to the approximate nearest neighbor cluster (search start cluster) search process will be described with reference to FIGS. 21, 22, and 23.

FIG. 21 is a diagram illustrating a first modification example for the approximate nearest neighbor cluster (search start cluster) search process. FIG. 21 corresponds to an example of determining a search start cluster without providing a structure for determining the search start cluster above the inter-cluster graph.

The lower part of FIG. 21 illustrates a positional relationship between a plurality of clusters (reference positions) and a plurality of vectors in the vector space. Such a positional relationship between the cluster (reference position) and the vector is based on, for each cluster, a data structure (Spatial Separated Clustering) in which a vector close to the reference position of the cluster belongs to this cluster.

The upper part of FIG. 21 illustrates the inter-cluster graph. In FIG. 21, the relationship between the reference position of each cluster on the inter-cluster graph and the reference position of each cluster in the vector space is represented by a dotted arrow.

The search start cluster search process is started from any cluster on the inter-cluster graph. A cluster from which the search start cluster search process is started is referred to as an entry point. In FIG. 21, instead of the structure for determining the search start cluster being not disposed above the inter-cluster graph, the long-distance edges on the inter-cluster graph are increased. In the search start cluster search process, a process of calculating the distance from the reference position of the cluster to the query is repeatedly executed for each cluster while traversing the inter-cluster graph, whereby the search start cluster is determined. In FIG. 21, the query is represented by a star.

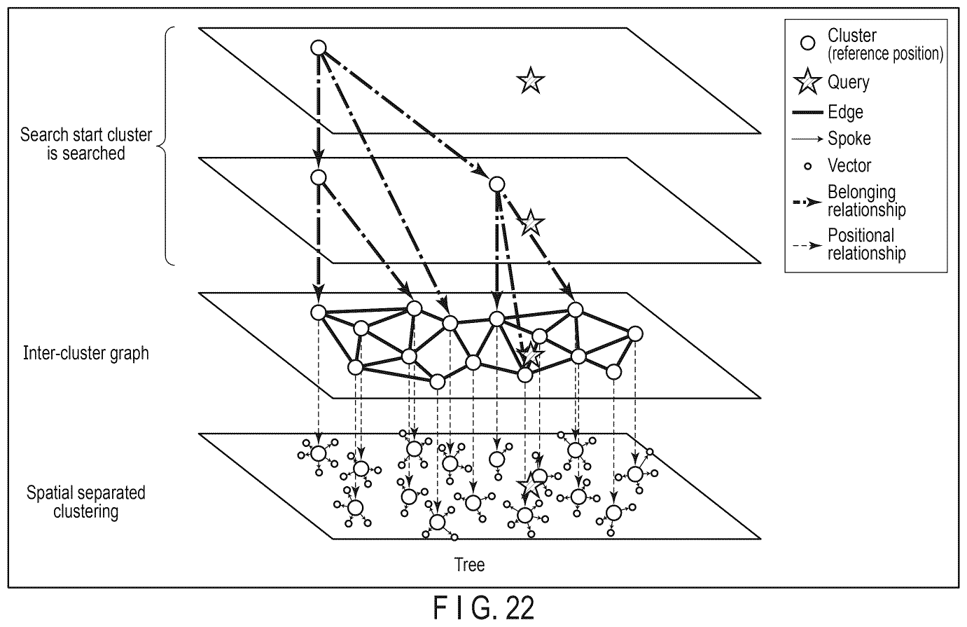

FIG. 22 is a diagram illustrating a second modification example for the approximate nearest neighbor cluster (search start cluster) search process.

In FIG. 22, a tree structure for determining a search start cluster is provided above the inter-cluster graph. The hierarchical cluster described above may be represented by such a tree structure. In FIG. 22, a belonging relationship between clusters such as the relationship between the higher layer cluster and the lower layer cluster belonging to the higher layer cluster is indicated by a bold arrow of a dashed-dotted line. The search start cluster search process can be executed in a procedure similar to the case of using the hierarchical cluster.

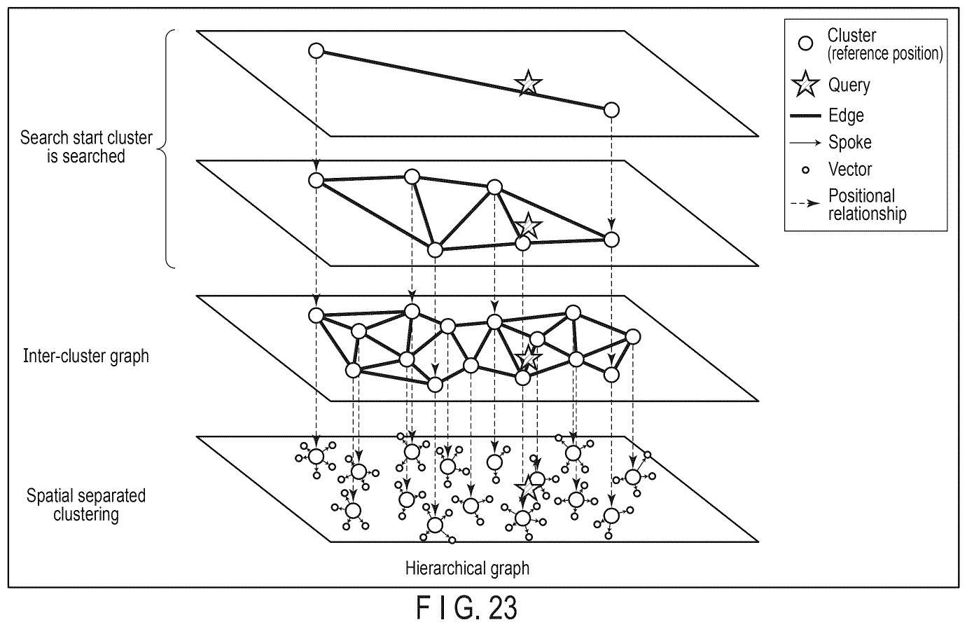

FIG. 23 is a diagram illustrating a third modification example for the approximate nearest neighbor cluster (search start cluster) search process.

In FIG. 23, a hierarchical graph is provided above the inter-cluster graph. In the hierarchical graph, the granularity of the graph becomes coarser in the higher layer. In the search start cluster search process, the search is started from the graph of the highest layer, and the process of searching for a cluster close to the query and the process of moving to the graph of the lower layer are repeatedly executed, whereby the search start cluster is determined.

As described above, according to the present embodiment, not a graph connecting vectors, but an inter-cluster graph connecting clusters each to which a plurality of vectors belongs is used.

Since the number of clusters is significantly less than the number of vectors, the number of neighbor lists for representing edges in the graph can be reduced, and even in a case of constructing a large-scale vector database of the billion scale or more, the increase in the size of the index information can be minimized.

When a new vector is added to the vector database, it is only necessary to register the new vector in one cluster, and it is not necessary to rewrite the neighbor list (edge information). Therefore, since the update frequency of the graph can be reduced and the amount of writing to the secondary storage device 14 is thereby reduced, it is possible to realize the extension of the life of the secondary storage device 14 such as the SSD and to shorten the time required for registering one vector.

In the approximate nearest neighbor vector search process, not only the process of searching for the nearest neighbor vector in the search start cluster from among the vectors belonging to the search start cluster having the reference position closest to the query but also the process of selecting one or more search target clusters close to the search start cluster by traversing the inter-cluster graph CG and searching for the nearest neighbor vector in each search start cluster from among the vectors belonging to each of the one or more search target clusters is executed. Therefore, not only the vector belonging to the search start cluster but also the vector belonging to each neighbor cluster of the search start cluster become the search target. As a result, it is possible to realize high search accuracy equivalent to that of an approximate nearest neighbor search algorithm using an inter-vector graph that connects vectors, while greatly reducing the number of times of rewriting edge information.

Therefore, the data amount that needs to be rewritten along with the update of the graph-based index can be reduced, and the approximate nearest neighbor search can be executed with sufficient search accuracy.

The process of determining the search start cluster can be executed by using the hierarchical cluster having a structure in which each lower layer cluster close to the reference position of the higher layer cluster belongs to each higher layer cluster. In this case, the search start cluster can be determined at a high speed by searching for the lower layer cluster having the reference position closest to the query from the lower layer clusters belonging to the target cluster by using the relative position information calculated in advance.

Each of the various functions described in the present embodiment may be realized by a circuit (processing circuit). Examples of the processing circuit include a programmed processor, such as a central processing unit (CPU). The processor executes each of the described functions by executing a computer program (command group) stored in the memory. The processor may be a microprocessor including an electric circuit. Examples of the processing circuit also include digital signal processors (DSP), application specific integrated circuits (ASIC), microcontrollers, controllers, and other electrical circuit components. Each of the components other than the CPU described in the present embodiment may also be realized by a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. An approximate nearest neighbor search method for a vector database configured to store a plurality of vectors each including a plurality of feature values respectively corresponding to a plurality of dimensions, the approximate nearest neighbor search method comprising:
managing cluster-based index information for defining a plurality of clusters each having a reference position, and each to which a group of vectors close to the reference position belongs;
managing graph-based index information for defining an inter-cluster graph including a plurality of nodes respectively corresponding to the plurality of clusters and a plurality of edges each connecting nodes that respectively correspond to clusters having reference positions close to each other;
receiving a query vector including a feature value for each of the plurality of dimensions;
executing a first process of determining, as a search start cluster, a cluster having a reference position closest to the query vector among the plurality of clusters;
searching for a vector closest to the query vector from vectors belonging to the search start cluster, as a nearest neighbor vector in the search start cluster;
selecting one or more search target clusters close to the search start cluster while traversing the inter-cluster graph, and searching for a vector closest to the query vector from vectors belonging to each of the one or more search target clusters, as a nearest neighbor vector in each search target cluster; and
outputting a vector closest to the query vector among the nearest neighbor vector searched for from the search start cluster and the nearest neighbor vectors searched for from the one or more search target clusters, as an approximate nearest neighbor vector of the query vector.

2. The approximate nearest neighbor search method according to claim 1, wherein
for each of the plurality of clusters, the cluster-based index information includes a belonging vector list indicating an identifier of each of vectors belonging to the cluster,
for each of the plurality of clusters, the graph-based index information includes a neighbor list indicating an identifier of each neighbor cluster connected to the cluster by an edge, and
the method further comprises:
in adding a new vector to the vector database,
specifying a first cluster having a reference position closest to the new vector among the plurality of clusters; and
registering the new vector in a first belonging vector list of the first cluster without rewriting the neighbor list corresponding to each of neighbor clusters of the first cluster.

3. The approximate nearest neighbor search method according to claim 2, further comprising:
In the adding the new vector to the vector database,
detecting that a total value obtained by adding 1 to the number of vectors already belonging to the first cluster exceeds an upper limit value;
in response to detecting that the total value exceeds the upper limit value, generating a new cluster having a reference position close to the reference position of the first cluster; and
executing a second process of adding the new cluster to the inter-cluster graph as a second cluster, wherein
the second process includes:
a process of registering an identifier of the first cluster and an identifier of a third cluster that is a neighbor cluster of the first cluster in a second neighbor list corresponding to the second cluster;
a process of registering an identifier of the second cluster in a first neighbor list corresponding to the first cluster;
a process of specifying one or more vectors of which a distance to the reference position of the second cluster is shorter than a distance to the reference position of the first cluster, from all of the vectors already belonging to the first cluster and the new vector;
a process of registering an identifier of each of the specified one or more vectors in a second belonging vector list corresponding to the second cluster; and
a process of deleting an identifier of each vector registered in the first belonging vector list corresponding to the first cluster among the specified one or more vectors, from the first belonging vector list.

4. The approximate nearest neighbor search method according to claim 3, further comprising:
detecting that the second cluster is determined as the search start cluster during execution of the second process; and
in response to detecting that the second cluster is determined as the search start cluster during the execution of the second process,
adding all vectors registered in the first belonging vector list of the first cluster to a search target, and
searching for a vector closest to the query vector as the nearest neighbor vector in the search start cluster, among all vectors registered in the second belonging vector list of the second cluster and all vectors registered in the first belonging vector list of the first cluster.

5. The approximate nearest neighbor search method according to claim 3, further comprising:
in deleting one vector from the vector database,
specifying a fourth cluster to which the one vector belongs;
deleting the one vector from a fourth belonging vector list of the fourth cluster; and
in response to detecting that the number of vectors belonging to the fourth cluster has become zero due to the deletion of the one vector,
specifying one or more fifth clusters registered as neighbor clusters of the fourth cluster in a fourth neighbor list of the fourth cluster, and
for each of the one or more fifth clusters, executing a process of deleting an identifier of the fourth cluster from a fifth neighbor list of the fifth cluster, a process of determining a cluster that is not registered in the fifth neighbor list of the fifth cluster and is registered in the fourth neighbor list of the fourth cluster, and a process of registering an identifier of the determined cluster in the fifth neighbor list of the fifth cluster.

6. The approximate nearest neighbor search method according to claim 1, wherein
the plurality of clusters are managed by using a hierarchized cluster structure including a lowest layer and a plurality of higher layers,
the lowest layer includes a plurality of lowest layer clusters each having a reference position, and each to which a group of vectors close to the reference position belongs,
the plurality of clusters respectively correspond to the plurality of lowest layer clusters,
a highest layer among the higher layers includes, as a highest layer cluster, a higher layer cluster having a reference position, and to which a plurality of lower layer clusters each having a reference position close to the reference position of the higher layer cluster belongs,
each of the higher layers excluding the highest layer includes a plurality of higher layer clusters each having a reference position, and each to which a plurality of lower layer clusters each having a reference position close to the reference position of the higher layer cluster belong,
for each of the higher layer clusters in the higher layers, the cluster-based index information includes (1) a lower layer cluster list indicating an identifier of each of the lower layer clusters belonging to the higher layer cluster, (2) first relative position information between the reference position of the higher layer cluster and the reference position of each of the lower layer clusters belonging to the higher layer cluster, and (3) second relative position information between the reference position of the higher layer cluster and the reference position of each of same layer clusters, each of the same layer clusters being another higher layer cluster other than the higher layer cluster, which is included in the same layer as a layer including the higher layer cluster, and
the executing of the first process includes
setting the highest layer cluster as a target cluster, and searching for a lower layer cluster having a reference position closest to the query vector from lower layer clusters belonging to the target cluster by using the first relative position information of the target cluster and the second relative position information corresponding to each of the lower layer clusters belonging to the target cluster,
executing a search process including a process of setting the searched lower layer cluster as a new target cluster, and a process of searching for the lower layer cluster having the reference position closest to the query vector from lower layer clusters belonging to the new target cluster, by using the first relative position information corresponding to the new target cluster and the second relative position information corresponding to each of the lower layer clusters belonging to the new target cluster, and
repeatedly executing the search process until one of the lowest layer clusters is searched for as the lower layer cluster having the reference position closest to the query vector.

7. The approximate nearest neighbor search method according to claim 6, wherein
for each of the lower layer clusters belonging to the higher layer cluster, the first relative position information includes distance information indicating a distance between the reference position of the higher layer cluster and the reference position of the lower layer cluster, and
for each of the same layer clusters, the second relative position information includes distance information indicating a distance between the reference position of the higher layer cluster and the reference position of the same layer cluster.

8. The approximate nearest neighbor search method according to claim 7, wherein
for each of the lower layer clusters belonging to the higher layer cluster, the first relative position information further includes direction information indicating a direction from the reference position of the higher layer cluster to the reference position of the lower layer cluster, and
for each of the same layer clusters, the second relative position information further includes direction information indicating a direction from the reference position of the higher layer cluster to the reference position of the same layer cluster.

9. The approximate nearest neighbor search method according to claim 1, wherein
the graph-based index information includes:
for each of the plurality of clusters, a neighbor list indicating an identifier of each neighbor cluster connected to the cluster by an edge; and
for each neighbor cluster of each of the plurality of clusters, first direction information indicating a direction from a reference position of the cluster to a reference position of the neighbor cluster, and
the method further comprises:
in executing the search for the one or more search target clusters close to the search start cluster,
calculating a first direction from the reference position of the search start cluster to the query vector; and
selecting a neighbor cluster having a direction most similar to the first direction, as one of the one or more search target clusters, with priority over other neighbor clusters of the search start cluster, by using the first direction information corresponding to each of the neighbor clusters of the search start cluster.

10. The approximate nearest neighbor search method according to claim 1, wherein
for each of the plurality of clusters, the graph-based index information includes a neighbor list indicating an identifier of each neighbor cluster connected to the cluster by an edge,
the plurality of vectors, the cluster-based index information, and the graph-based index information are stored in a secondary storage device, and
the neighbor list is stored in a second storage area in the secondary storage device different from a first storage area in the secondary storage device, the plurality of vectors being stored in the first storage area.

11. An approximate nearest neighbor search system comprising:
a main memory;
a secondary storage device configured to store a vector database in which a plurality of vectors each including a plurality of feature values respectively corresponding to a plurality of dimensions are stored; and
a processor configured to access the main memory and the secondary storage device,
the processor being further configured to:
manage cluster-based index information for defining a plurality of clusters each having a reference position, and each to which a group of vectors close to the reference position belongs;
manage graph-based index information for defining an inter-cluster graph including a plurality of nodes respectively corresponding to the plurality of clusters and a plurality of edges each connecting nodes that respectively correspond to clusters having reference positions close to each other;
receive a query vector including a feature value for each of the plurality of dimensions;
execute a first process of determining, as a search start cluster, a cluster having a reference position closest to the query vector among the plurality of clusters;
search for a vector closest to the query vector from vectors belonging to the search start cluster, as a nearest neighbor vector in the search start cluster;
select one or more search target clusters close to the search start cluster while traversing the inter-cluster graph, and search for a vector closest to the query vector from vectors belonging to each of the one or more search target clusters, as a nearest neighbor vector in each search target cluster; and
output a vector closest to the query vector among the nearest neighbor vector searched for from the search start cluster and the nearest neighbor vectors searched for from the one or more search target clusters, as an approximate nearest neighbor vector of the query vector.

12. The approximate nearest neighbor search system according to claim 11, wherein
for each of the plurality of clusters, the cluster-based index information includes a belonging vector list indicating an identifier of each of vectors belonging to the cluster,
for each of the plurality of clusters, the graph-based index information includes a neighbor list indicating an identifier of each neighbor cluster connected to the cluster by an edge, and
the processor is further configured to:
in adding a new vector to the vector database,
specify a first cluster having a reference position closest to the new vector among the plurality of clusters; and
register the new vector in a first belonging vector list of the first cluster without rewriting the neighbor list corresponding to each of neighbor clusters of the first cluster.

13. The approximate nearest neighbor search system according to claim 12, wherein
the processor is further configured to:
in the adding the new vector to the vector database,
generate a new cluster having a reference position close to the reference position of the first cluster in response to detecting that a total value obtained by adding 1 to the number of vectors already belonging to the first cluster exceeds an upper limit value; and
execute a second process of adding the new cluster to the inter-cluster graph as a second cluster, and
the second process includes:
a process of registering an identifier of the first cluster and an identifier of a third cluster that is a neighbor cluster of the first cluster in a second neighbor list corresponding to the second cluster;
a process of registering an identifier of the second cluster in a first neighbor list corresponding to the first cluster;
a process of specifying one or more vectors of which a distance to the reference position of the second cluster is shorter than a distance to the reference position of the first cluster, from all of the vectors already belonging to the first cluster and the new vector;
a process of registering an identifier of each of the specified one or more vectors in a second belonging vector list corresponding to the second cluster; and
a process of deleting an identifier of each vector registered in the first belonging vector list corresponding to the first cluster among the specified one or more vectors, from the first belonging vector list.

14. The approximate nearest neighbor search system according to claim 13, wherein
the processor is further configured to:
in response to detecting that the second cluster is determined as the search start cluster during the execution of the second process,
add all vectors registered in the first belonging vector list of the first cluster to a search target; and
search for a vector closest to the query vector as the nearest neighbor vector in the search start cluster, among all vectors registered in the second belonging vector list of the second cluster and all vectors registered in the first belonging vector list of the first cluster.

15. The approximate nearest neighbor search system according to claim 13, wherein
the processor is further configured to:
in deleting one vector from the vector database,
specify a fourth cluster to which the one vector belongs;
delete the one vector from a fourth belonging vector list of the fourth cluster; and
in response to detecting that the number of vectors belonging to the fourth cluster has become zero due to the deletion of the one vector,
specify one or more fifth clusters registered as neighbor clusters of the fourth cluster in a fourth neighbor list of the fourth cluster, and
for each of the one or more fifth clusters, execute a process of deleting an identifier of the fourth cluster from a fifth neighbor list of the fifth cluster, a process of determining a cluster that is not registered in the fifth neighbor list of the fifth cluster and is registered in the fourth neighbor list of the fourth cluster, and a process of registering an identifier of the determined cluster in the fifth neighbor list of the fifth cluster.

16. The approximate nearest neighbor search system according to claim 1, wherein
the plurality of clusters are managed by using a hierarchized cluster structure including a lowest layer and a plurality of higher layers,
the lowest layer includes a plurality of lowest layer clusters each having a reference position, and each to which a group of vectors close to the reference position belongs,
the plurality of clusters respectively correspond to the plurality of lowest layer clusters,
a highest layer among the higher layers includes, as a highest layer cluster, a higher layer cluster having a reference position, and to which a plurality of lower layer clusters each having a reference position close to the reference position of the higher layer cluster belongs,
each of the higher layers excluding the highest layer includes a plurality of higher layer clusters each having a reference position, and each to which a plurality of lower layer clusters each having a reference position close to the reference position of the higher layer cluster belong,
for each of the higher layer clusters in the higher layers, the cluster-based index information includes (1) a lower layer cluster list indicating an identifier of each of the lower layer clusters belonging to the higher layer cluster, (2) first relative position information between the reference position of the higher layer cluster and the reference position of each of the lower layer clusters belonging to the higher layer cluster, and (3) second relative position information between the reference position of the higher layer cluster and the reference position of each of same layer clusters, each of the same layer clusters being another higher layer cluster other than the higher layer cluster, which is included in the same layer as a layer including the higher layer cluster, and
the processor is further configured to:
in executing the first process,
set the highest layer cluster as a target cluster, and search for a lower layer cluster having a reference position closest to the query vector from lower layer clusters belonging to the target cluster by using the first relative position information of the target cluster and the second relative position information corresponding to each of the lower layer clusters belonging to the target cluster;
execute a search process including a process of setting the searched lower layer cluster as a new target cluster, and a process of searching for the lower layer cluster having the reference position closest to the query vector from lower layer clusters belonging to the new target cluster, by using the first relative position information corresponding to the new target cluster and the second relative position information corresponding to each of the lower layer clusters belonging to the new target cluster; and
repeatedly execute the search process until one of the lowest layer clusters is searched for as the lower layer cluster having the reference position closest to the query vector.

17. The approximate nearest neighbor search system according to claim 16, wherein
for each of the lower layer clusters belonging to the higher layer cluster, the first relative position information includes distance information indicating a distance between the reference position of the higher layer cluster and the reference position of the lower layer cluster, and
for each of the same layer clusters, the second relative position information includes distance information indicating a distance between the reference position of the higher layer cluster and the reference position of the same layer cluster.

18. The approximate nearest neighbor search system according to claim 17, wherein
for each of the lower layer clusters belonging to the higher layer cluster, the first relative position information further includes direction information indicating a direction from the reference position of the higher layer cluster to the reference position of the lower layer cluster, and
for each of the same layer clusters, the second relative position information further includes direction information indicating a direction from the reference position of the higher layer cluster to the reference position of the same layer cluster.

19. The approximate nearest neighbor search system according to claim 11, wherein
the graph-based index information includes:
for each of the plurality of clusters, a neighbor list indicating an identifier of each neighbor cluster connected to the cluster by an edge; and
for each neighbor cluster of each of the plurality of clusters, first direction information indicating a direction from a reference position of the cluster to a reference position of the neighbor cluster, and
the processor is further configured to:
in executing the search for the one or more search target clusters close to the search start cluster,
calculate a first direction from the reference position of the search start cluster to the query vector; and
select a neighbor cluster having a direction most similar to the first direction, as one of the one or more search target clusters, with priority over other neighbor clusters of the search start cluster, by using the first direction information corresponding to each of the neighbor clusters of the search start cluster.

20. The approximate nearest neighbor search system according to claim 11, wherein
for each of the plurality of clusters, the graph-based index information includes a neighbor list indicating an identifier of each neighbor cluster connected to the cluster by an edge,
the plurality of vectors, the cluster-based index information, and the graph-based index information are stored in the secondary storage device, and
the neighbor list is stored in a second storage area in the secondary storage device different from a first storage area in the secondary storage device, the plurality of vectors being stored in the first storage area.
